(19) United States
(12) Patent Application Publication
(10) Pub. No.: US 2008/0010612 A1
(43) Pub. Date: Jan. 10, 2008

(54) INFORMATION PROCESSING APPARATUS, INFORMATION PROCESSING SYSTEM, CONTROL METHOD THEREOF, PROGRAM, AND STORAGE MEDIUM

(75) Inventors: Takeshi Ooyama, Yokohama-shi (JP); Hironobu Kitabatake, Ohta-ku (JP); Hidetoshi Asasaka, Sagamihara-shi (JP); Shuji Someya, Adachi-ku (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/750,908

(22) Filed: May 18, 2007

(30) Foreign Application Priority Data
May 24, 2006 (JP) 2006-144353

(51) Int. Cl. G06F 15/00

(52) U.S. Cl. 715/831

(57) ABSTRACT

Based on plural kinds of image data produced by changing a layout of input first image data, at least first feature information and second feature information are extracted and stored in a correspondent relation. Third feature information extracted from third image data is compared with the stored first feature information and second feature information. When a result of the comparison shows that the third feature information is matched with one of the first feature information and the second feature information, it is determined that the third image data is identical to the first image data.

### BACKGROUND OF THE INVENTION

1. Field of the Invention

The present invention relates to an information processing apparatus and an information processing system each of which performs information processing by using feature information extracted from image data. Also, the present invention relates to a control method for the information processing apparatus and system, a program, and a storage medium.

2. Description of the Related Art

Hitherto, there are known techniques for performing various kinds of information processing by using feature information extracted from image data. In the field of assuring originality by using feature information of an image, for example, the following technique is proposed. Feature information is extracted from digitized data of an image on a document and is registered on a network. Thereafter, when originality is to be verified, feature information extracted from a target document is compared with the previously registered feature information. With that technique, unless two sets of image data input respectively at the time of registration and verification are changed or tampered, two values of the feature information are matched with each other, thus assuring originality of the image data (see, e.g., Japanese Patent Laid-Open No. 2004-320378).

On the other hand, with recent diversified development of the printing technology, a plurality of pages can be printed on the same side of one recording medium in various layouts. For example, when image data of an original, i.e., an original document, is received and output for printing, N pages can be output to be arranged on the same side of one print sheet (hereinafter referred to as “Nin1”).

In trying to perform a comparison with the feature information extracted from the image on the original and registered in advance as described above, however, a problem occurs when a document to be verified is printed in the “Nin1” layout. More specifically, in Japanese Patent Laid-Open No. 2004-320378, no considerations are paid to a document printed in the “Nin1” layout, and even the document printed in the “Nin1” layout is interpreted as one page. Therefore, unless the registered feature information is also extracted in the “Nin1” layout, two values of the feature information are mismatched and proper determination can not be resulted even if the verified document has the same contents as the original.

To solve the above-mentioned problem, a technique is proposed which can properly extract feature information and execute a search using the extracted feature information even in the case of a document output in the “Nin1” layout. More specifically, at the time of reading a document, feature information in each of target areas corresponding to the number of pages contained in the document is extracted and a document image is searched using the extracted feature information for each page. With such a technique, even when a document is output in the “Nin1” layout, the feature information can be properly extracted and the document having the same contents can be searched for (see, e.g., Japanese Patent Laid-Open No. 2005-004724).

However, the above-described related art has the problem as follows. For example, when feature information of an image obtained by reading a document is extracted to make a comparison (check) for verification, it sometimes happens that a user does not recognize a target document being one obtained from an original by changing its layout (i.e., one printed after changing a value of N of “Nin1”). In such a case, it is impossible to designate the matter that the target document is a document printed with change of the layout, and to properly extract the feature information. Also, even in trying to automatically determine whether the target document is one obtained from an original by changing its layout, if the document registered as an original has the “Nin1” layout, the feature information cannot be properly extracted based on the determination result.

In addition, it is not convenient for the user to designate whether the layout is changed or not each time a document to be verified is read. Further, automatic determination requires a complicated process and increases a load imposed on a processing apparatus.

### SUMMARY OF THE INVENTION

In view of the above-described problems, the present invention provides an information processing apparatus and an information processing system in each of which, when identity of image data is determined by comparing feature information extracted from the image data with previously registered feature information, proper determination can be performed with high efficiency even if the image data has a different layout changed from the layout of the registered image data. Also, the present invention provides a method for the information processing apparatus and system, as well as a program and a storage medium for realizing the method.

According to an aspect of the present invention, an information processing apparatus includes an input unit configured to input image data, an extraction unit configured to extract feature information from the image data, a changing unit configured to change a layout of first image data input by the input unit, a memory unit configured to store at least first feature information and second feature information in a correspondent relation, the first feature information and the second feature information being respectively extracted by the extraction unit from at least two different image data contained in plural kinds of image data having a plurality of layouts based on the first image data, the plural kinds of image data including at least the first image data and second image data of which layout is changed by the changing unit based on the first image data, a comparison unit configured to compare third feature information extracted from third image data by the extraction unit with the first feature information and the second feature information both stored in the memory unit, and a determination unit configured to determine that the third image data is identical to the first image data when a result of the comparison by the comparison unit shows that the third feature information is matched with one of the first feature information and the second feature information.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principle of the invention.

FIG. 1 is a block diagram of a multi-function printer according to an exemplary embodiment of the present invention.

FIG. 2 is an external appearance view of an operating panel in the exemplary embodiment of the present invention.

FIG. 3 is an overall external appearance view of the multi-function printer in the exemplary embodiment of the present invention.

FIG. 4 is an illustration showing the configuration of an originality assurance system in the exemplary embodiment of the present invention.

FIG. 5 is a block diagram of an originality assurance server in the exemplary embodiment of the present invention.

FIG. 6 shows a user authentication screen displayed on an operating panel user-interface in the exemplary embodiment of the present invention.

FIG. 7 shows a “copy” basic screen displayed on the operating panel user-interface in the exemplary embodiment of the present invention.

FIG. 8 shows a “send/fax” basic screen displayed on the operating panel user-interface in the exemplary embodiment of the present invention.

FIG. 9 shows a reading setting screen displayed on the operating panel user-interface in the exemplary embodiment of the present invention.

FIG. 10 shows an original information registration setting screen displayed on the operating panel user-interface in the exemplary embodiment of the present invention.

FIG. 11 shows a registration detailed setting screen displayed on the operating panel user-interface in the exemplary embodiment of the present invention.

FIG. 12 shows a list of kinds of layout changes in the exemplary embodiment of the present invention.

FIG. 13 shows a list of kinds of arrangement sequence changes in the exemplary embodiment of the present invention.

FIG. 14 shows a list of kinds of page orientation changes in the exemplary embodiment of the present invention.

FIG. 15 shows a list of kinds of page sequence changes in the exemplary embodiment of the present invention.

FIG. 16 shows a registration completion screen displayed on the operating panel user-interface in the exemplary embodiment of the present invention.

FIG. 17 shows an original information verification setting screen displayed on the operating panel user-interface in the exemplary embodiment of the present invention.

FIG. 18 shows a verification detailed setting screen displayed on the operating panel user-interface in the exemplary embodiment of the present invention.

FIG. 19 is a flowchart showing operations in the exemplary embodiment of the present invention.

FIG. 20 is a flowchart showing operations in the exemplary embodiment of the present invention.

FIG. 21 is a flowchart showing operations in the exemplary embodiment of the present invention.

FIG. 22 shows a verification detailed setting screen displayed on the operating panel user-interface in the exemplary embodiment of the present invention.

FIG. 23 is a flowchart showing operations in the exemplary embodiment of the present invention.

FIG. 24 is a flowchart showing operations in the exemplary embodiment of the present invention.

FIG. 25 is a flowchart showing operations in the exemplary embodiment of the present invention.

FIG. 26 shows a verification detailed setting screen displayed on the operating panel user-interface in the exemplary embodiment of the present invention.

FIG. 27 is a flowchart showing operations in the exemplary embodiment of the present invention.

FIG. 28 shows a feature information management table in the exemplary embodiment of the present invention.

FIG. 29 is a flowchart showing operations in the exemplary embodiment of the present invention.

FIG. 30 is a flowchart showing operations in the exemplary embodiment of the present invention.

FIG. 31 is a flowchart showing operations in the exemplary embodiment of the present invention.

### DESCRIPTION OF THE EMBODIMENTS

Exemplary embodiments of the present invention will be described below.

### First Exemplary Embodiment

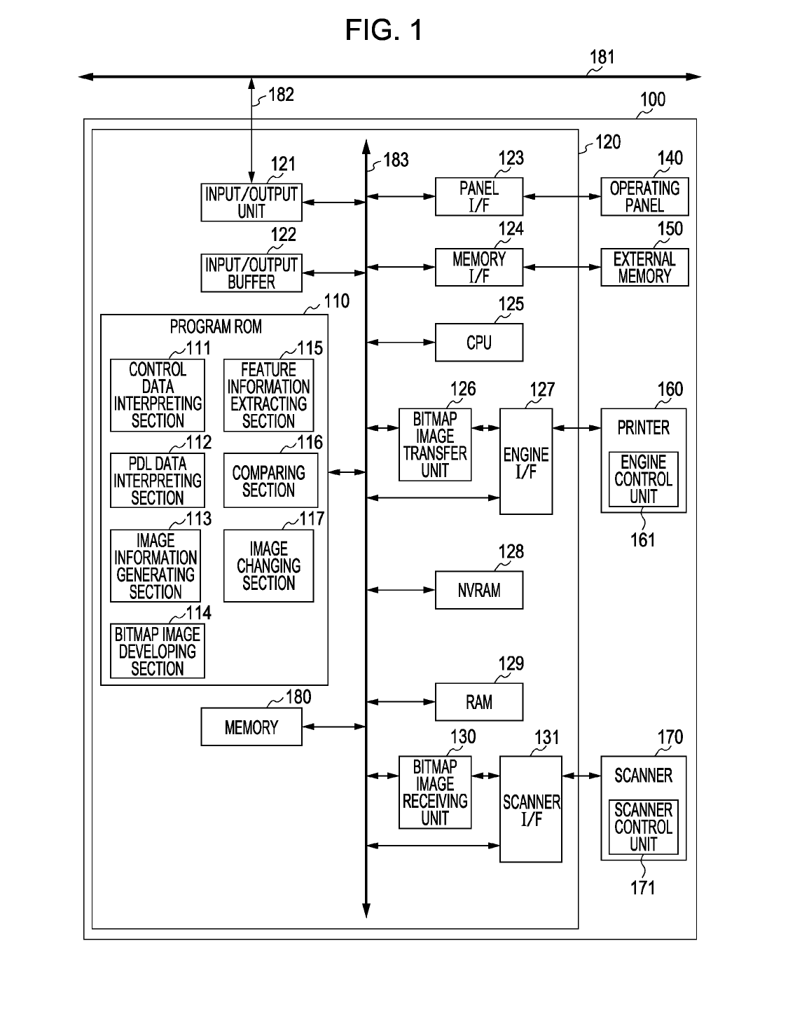

FIG. 1 is system block diagram of a multi-function printer (MFP), as one typical example a composite machine, constituting a part of an originality assurance system according to a first exemplary embodiment. A multi-function printer (MFP) 100 is able to read (scan) and input an image on a document, to print or store input image data, and/or to send the image data to other external devices. The main components of the MFP 100 include a control unit 120 for executing control of the MFP, a printer 160 for printing an output image on a sheet of recording paper, and a scanner 170 for reading the image from the document and inputting the read image as image data to the inside of the MFP (also called the apparatus hereinafter).

The control unit 120 is connected to the external devices, such as individual client terminals and server terminals, via a network cable 182 connected to a network 181. The control unit 120 performs communication with the individual terminals through an input/output unit 121 which controls input/output of data from and to the external devices. An input/output buffer 122 is utilized when sending and receiving various control codes for printing which are input via the network, various PDL (Page Description Language) data, and various data regarding the MFP. A CPU 125 controls overall operations of the control unit 120. A program ROM 110 stores programs describing operations of the CPU 125. The CPU 125 realizes various functions of the MFP 100 by reading and executing the programs stored in the program ROM 110.

A RAM 129 serves as a work memory used to execute calculations required for interpretation and printing of the control code and data, and reading of the image, as well as processing of the input and output image data. A nonvolatile RAM (NVRAM) 128 stores data that should be held even in the case of power-down of the apparatus. A control data interpreting section 111 and a PDL data interpreting section 112 in the program ROM 110 interpret respectively printing control data and PDL data which are received from an external PC, etc. An image information generating section 113 generates various image objects. A bitmap image developing section 114 develops an image object into bitmap image data. An image changing section 117 executes various kinds of changing processes based on the bitmap image data which has been developed by the bitmap image developing section 114. More specifically, the image changing section 117 generates bitmap image data in a state resulting from changing, e.g., a layout of the image data (i.e., “Nini” layout in which N pages (N>0) are arranged on the same side of one recording medium), an orientation of each page, and a sequence of pages. While in this first exemplary embodiment feature information is extracted from one set of image data for each of plural different layouts thereof as described later, the bitmap image developing section 114 can also execute the processing that is executed by the image changing section 117.

A feature information extracting section 115 extracts feature information from the bitmap image data obtained from the bitmap image developing section 114 or the image changing section 117. The feature information extracted herein can be, e.g., a Hash value that is calculated as a quite different value if the image data differs even slightly. Alternatively, the feature information can also be extracted by other suitable methods. For example, when the feature information is calculated based on position information of an image feature point, the feature information can be extracted by a method of calculating the same value of feature information while ignoring a position shift of the feature point within a preset range. The feature information extracted by the feature information extracting section 115 is sent to the external device via the network 181, or it is stored in a memory 180. A bitmap image transfer unit 126 transfers, to the printer 160, the bitmap image developed by the bitmap image developing section 114, a bitmap image obtained by reading a document via the scanner 170, etc. An engine I/F 127 serves as an interface (I/F) for connecting the bitmap image transfer unit 126 and an engine control unit 161 in the printer 160 to each other.

A bitmap image receiving unit 130 receives the bitmap image read by the scanner 170. A scanner I/F 131 serves as an I/F for connecting a scanner control unit 171 in the scanner 170 and the bitmap image receiving unit 130 to each other.

A comparing section 116 compares the feature information extracted by the feature information extracting section 115 from the bitmap image, which has been received by the bitmap image receiving unit 130, with the feature information stored in the memory 180. If the comparison process is executed by an originality assurance server 403 described later, the comparing section 116 is not required. Based on the comparison result of the comparing section 116, the CPU 125 determines whether two sets of document information from each of which the feature information has been extracted are identical to each other. Details of the comparison and determination process will be described later.

An operating panel 140 receives instructions for operations of the MFP from a user and displays errors, processing results, operation guides, etc. A panel I/F 123 serves as an I/F for connecting the operating panel 140 and the control unit 120 with each other. An external memory 150 is able to store print data, image data input from the exterior, and various items of information used in the apparatus. The external memory 150 is connected to the control unit 120 via a memory I/F 124. A system bus 183 interconnects the above-described units.

The engine control unit 161 installed in the printer 160 executes printing control ranging from supply of sheets, to printing on the sheets, and then to ejection of the sheets. The scanner control unit 171 installed in the scanner 170 controls scanning operations including feed of a document to scan an image, reading of the image, and ejection of the document.

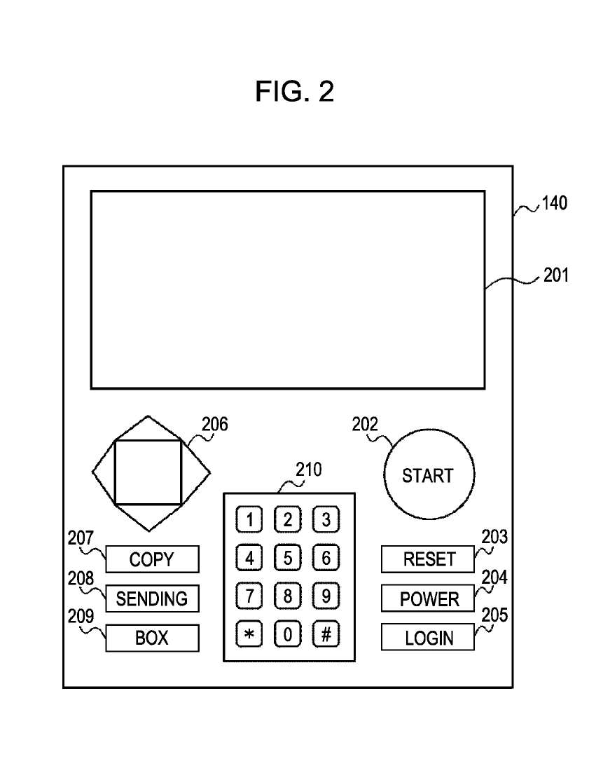

FIG. 2 is an external appearance view of the operating panel 140. A liquid crystal panel section 201 displays apparatus information, such as preview of a registered image and a printing situation, and the results of various processes. The liquid crystal panel section 201 is constituted as a touch panel which can detect information of the position touched by the user to instruct various processes and to enter character information. A start button 202 is pressed when the user instructs start of, e.g., the copying function and the sending function.

Other hard keys include, for example, a reset button 203 for resetting the apparatus, a power button 204 for turning on/off supply of power, a ten-digit keypad 210 for entering, e.g., the number of copies, and a cursor key 206 for operating a cursor displayed in the liquid crystal panel section 201. Further, a “copy” key 207, a “send” key 208, and a “box” key 209 are disposed as mode keys for switching a function mode of the apparatus.

A login key 205 is pressed when the user receives user authentication prior to operating the apparatus. When the login key 205 is pressed in a state of the user being already logged in, the user can log out. Detailed operation for the user authentication will be described later.

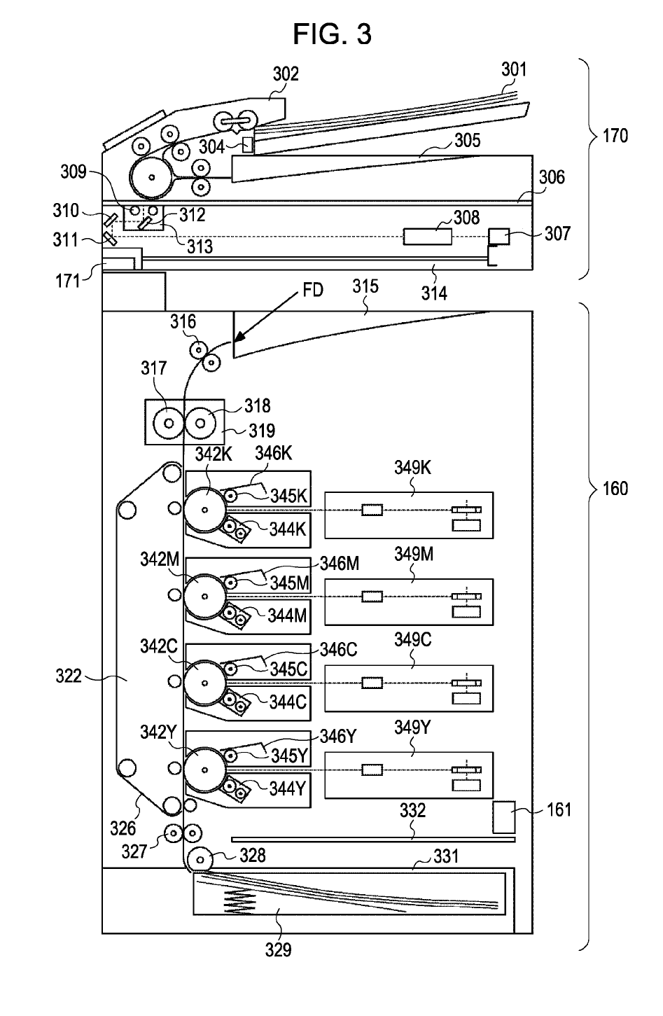

FIG. 3 shows an overall construction of the multi-function printer (MFP) 100. The MFP 100 includes a housing 315 of the printer 160, a document feed unit 302 for feeding a document, and a scanner unit 314 for scanning the document to read image data, the latter two 302 and 314 constituting the scanner 170.

The housing 315 houses various mechanisms constituting the printer 160, including the engine control unit 161 for executing control of various printing processes by those mechanisms, and a control board container 332 for containing the control unit 120 shown in FIG. 1.

The MFP 100 is able to perform full-color printing using toners in four colors of cyan (C), magenta (M), yellow (Y) and black (K). The MFP 100 includes four photosensitive drums 342 (342C, 342M, 342Y and 342K), serving as image bearing members, which are arranged side by side perpendicularly to a sheet conveying direction. Charging apparatuses 345 (345C, 345M, 345Y and 345K) uniformly charge the surfaces of the corresponding photosensitive drums 342. Printing scanners 349 (349C, 349M, 349Y and 349K) illuminate laser beams in accordance with image information while scanning the laser beams, thus forming electrostatic latent images on the corresponding photosensitive drums 342.

Developing apparatuses 344 (344C, 344M, 344Y and 344K) deposit toners onto the electrostatic latent images, thus developing the latent images as toner images. An electrostatic transfer apparatus 322 transfers the toner images on the photosensitive drums 342 to a transfer material (paper). Cleaning apparatuses 346 (346C, 346M, 346Y and 346K) remove the toners remaining on the surfaces of the corresponding photosensitive drums 342 after the transfer of the toner images.

The electrostatic conveying belt 326 is a belt member which is cyclically moved in an oppositely facing and contact relation to all the photosensitive drums 342. The electrostatic conveying belt 326 is supported by rollers at four axes to extend in the vertical direction and is cyclically moved while electrostatically attracting the transfer material onto its outer surface, which is positioned on the left side of the photosensitive drums 342 as viewed in FIG. 3, such that the transfer material is successively brought into contact with the photosensitive drums 342. Thus, the transfer material is conveyed to each transfer position by the electrostatic conveying belt 326, and the toner images on the photosensitive drums 342 are transferred to the transfer material in sequence.

A paper feed section 331 feeds the transfer material to an image forming section and includes a paper cassette 329 in which a plurality of transfer materials in the form of stacked sheets are placed. In an image forming process, a paper feed roller 328 and a registration roller pair 327 are rotated in sync with the image forming operation to separate and feed the transfer materials from the paper cassette 329 one by one. The leading end of the transfer material strikes against the registration roller pair 327 and is temporarily stopped there to form a loop. Thereafter, the transfer material is further fed to the electrostatic conveying belt 326.

A fusing section 319 fuses a plurality of toner images transferred to the transfer material. The fusing section 319 includes a rotatable heating roller 318 and a pressing roller 317. The pressing roller 317 contacts the heating roller 318 and applies heat and pressure to the transfer material. In other words, when the transfer material including the toner images transferred from the photosensitive drums 342 passes through the fusing section 319, the transfer material is conveyed by the fusing roller pair 317 and 318, and at the same time it is subjected to heat and pressure applied from the fusing roller pair, and the toner images in plural colors are fused onto the surface of the transfer material. The transfer material having the fused toner images is then ejected to an output section by an ejection roller pair 316.

Further, the MFP 100 is able to read and input an image on a document by the scanner 170. A document feed unit (DF unit) 302 of the scanner 170 feeds documents 301 toward a position over a platen glass 306 page by page in sequence from the top. After the document has been read by the scanner unit 314, the document on the platen glass 306 is ejected to an output tray 305.

A sensor 304 detects the presence or absence of the document. In the scanner unit 314, when the document is conveyed to the position over the platen glass 306, a lamp 309 is turned on and an optical unit 313 is started to move for an exposure scan of the document. At that time, a light reflected by the document is introduced to a CCD image sensor (hereinafter referred to simply as a “CCD”) 307 through mirrors 312, 310 and 311 and a lens 308. An image of the document thus scanned is read by the CCD 307. Image data output from the CCD 307 is subjected to predetermined processing and then transmitted to the control unit 120 through the scanner I/F 131.

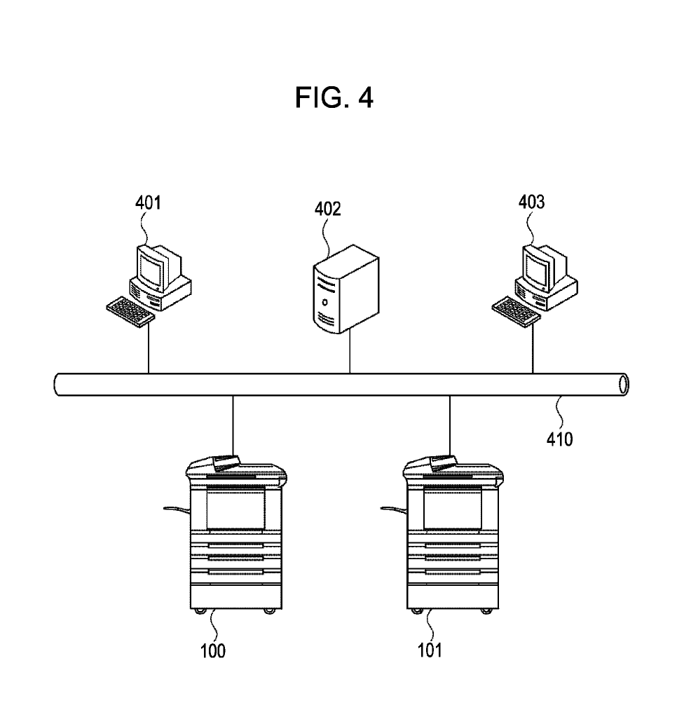

FIG. 4 is an illustration showing the configuration of an originality assurance system in the first exemplary embodiment. The above-described multi-function printer (MFP) 100 and another MFP 101 having the same functions as the MFP 100 are utilized as input/output terminals for various data. Also, the MFPs 100 and 101 are connected to a LAN 410 and are able to send and receive data through various kinds of communications with clients and servers 401, 402, 403 which are also connected to the LAN 410. In the illustrated system, the individual terminals can also be interconnected via any of other suitable communication media, such as the Internet, instead of the LAN 410.

The originality assurance server 403 is connected to the LAN 410 and receives a service request for originality assurance from each of the MFPs 100 and 101. More specifically, to register information designated as original from the MFPs 100 and 101, the originality assurance server 403 receives and registers information (such as image data or feature information) based on a document to be registered. Also, the originality assurance server 403 accepts a request for comparison (verification) with the original from each of the MFPs 100 and 101, compares received information with the information stored in the server itself, and determines similarity therebetween.

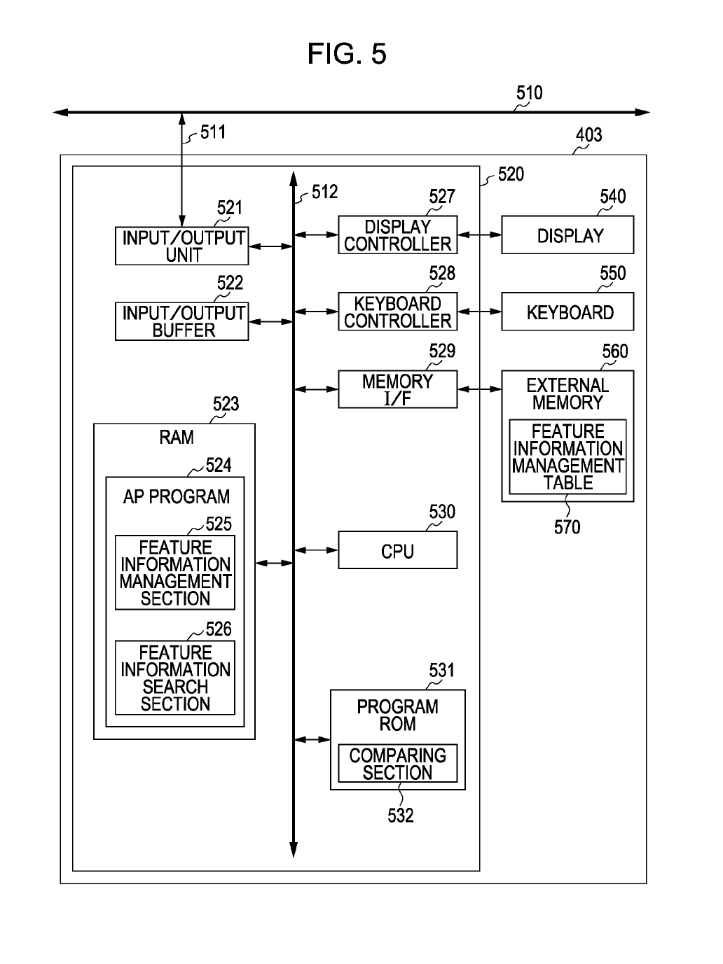

FIG. 5 is a block diagram of the originality assurance server 403. A control unit 520 includes a CPU 530 for controlling overall operations of the originality assurance server 403, and a program ROM 531 for storing programs that describe operations of the CPU 530. The CPU 530 realizes various functions of the originality assurance server 403 by reading and executing the programs stored in the program ROM 531. Further, the control unit 520 performs communication with the individual terminals through an input/output unit 521 which controls input/output of data from and to other devices connected to a network 510 via a cable 511. The program ROM 531 includes a comparing section 532 having a similar function to that of the comparing section 116 in the MFP 100.

An input/output buffer 522 is utilized when sending and receiving feature information and various data, as well as various control codes which are input via the network. A RAM 523 serves as a work memory used to execute calculations required for interpretation and printing of the control codes and data, and processing of print data. An application program (AP program) 524 stored in the RAM 523 describes operations of application software, a driver, etc. which operate on a computer. A feature information management section 525 serves as an AP program for receiving and managing the feature information extracted from a document as an original when original information is registered. A feature information search section 526 searches for demanded feature information of an original based on received search conditions when the original information is verified.

A display 540 displays a computer-processed image to the user, and a display controller 527 controls display of the image represented on the display 540. A keyboard 550 receives a user's input, and a keyboard controller 528 controls the received user's input. An external memory 560 is a nonvolatile memory, such as a hard disk, which is used to store print data, various kinds of information necessary for a host computer. The external memory 560 is connected to the control unit 520 via a memory I/F 529.

The external memory 560 includes a feature information management table 570 which manages the feature information stored (registered) in the originality assurance server 403. The above-described functional components are interconnected via a system bus 512.

An originality assurance process executed with the thus-arranged system configuration will be described in detail below. In the following description, it is assumed that the term “original information” represents document information designated as an original, the term “registered information” represents document information registered as an original, and the term “verified information” represents document information for which originality is to be verified.

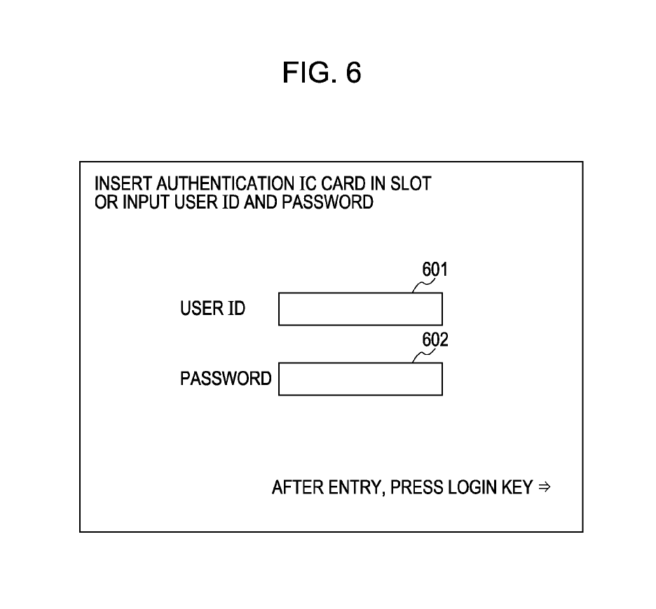

FIG. 6 shows one example of a (user dialog) screen displayed on the liquid crystal panel section 201 of the operating panel 140 shown in FIG. 2. More specifically, FIG. 6 shows a screen on which, prior to operating the MFP 100, the user inputs the user ID and the password for login with user authentication. When the user inputs respectively the user ID in a user ID entry box 601 and the password in password entry box 602 and then presses the login key 205 shown in FIG. 2, the input information is compared with the user information previously registered in the memory 180.

If the input information is matched with the registered user information, the user is allowed to log in. Instead of inputting the user ID and the password, the user can also insert an IC card for reading of authentication information stored in the IC card.

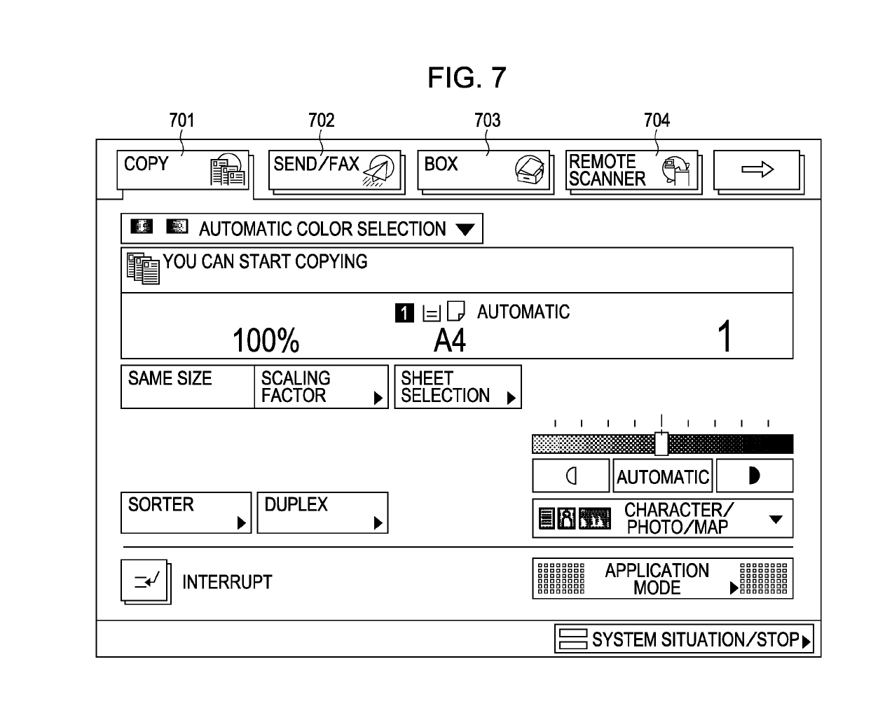

FIG. 7 shows a “copy” basic screen displayed first after the user has logged in. Any of mode keys 701-704 is pressed when a function mode of the MFP 100 is switched from one to another. In the case of the so-called copying process in which data is input from the scanner 170 and the data is output by the printer 160, the process is started by pressing the start button 202 after setting details on the “copy” basic screen.

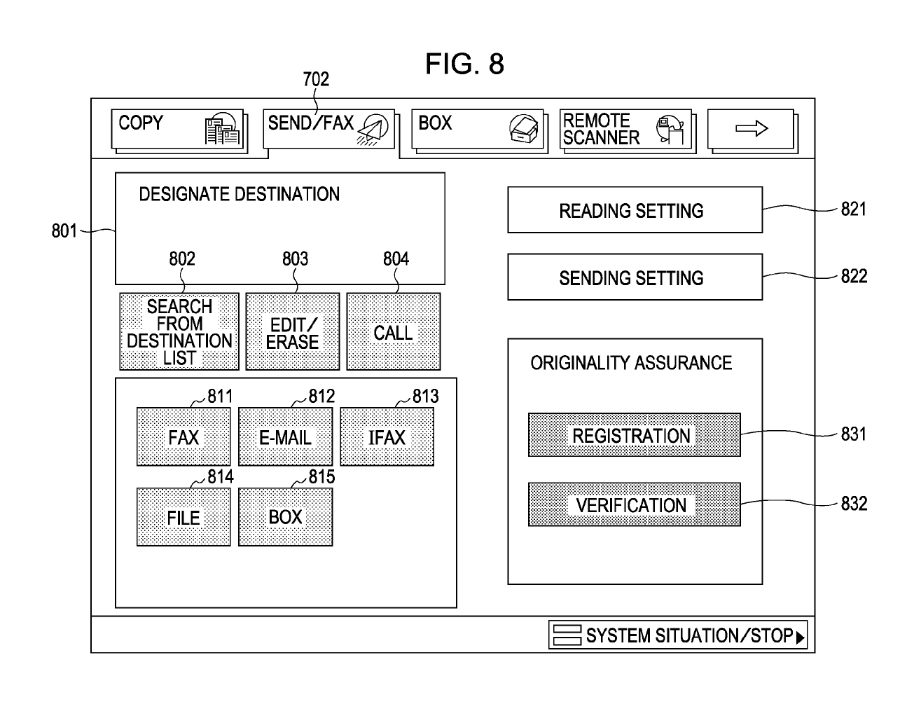

FIG. 8 shows a “send/fax” basic screen displayed when the mode key 702 is pressed. This screen is used to perform various detailed settings when the data input from the scanner 170 is sent to the external device or it is stored in a memory area prepared in the MFP 100, or when facsimile data is sent and received.

A destination display box 801 displays the destination set from, e.g., a destination list described later. A “search from destination list” button 802 is pressed when destination information previously registered is read out and set as the destination. An “edit/erase” button 803 is pressed when the destination already set is edited or erased, or when a new destination is directly input. A “call” button 804 is pressed when the destination information used in the past is read out.

Sending method selection buttons 811-815 are each pressed to display a screen to perform detailed setting for corresponding to one of fax, E-mail and other sending methods. For example, in the case of internet facsimile (IFAX) in which E-mail is sent with an attachment of an image in the facsimile format, the mail address of the destination, resolution, and the compression method, etc. can be set.

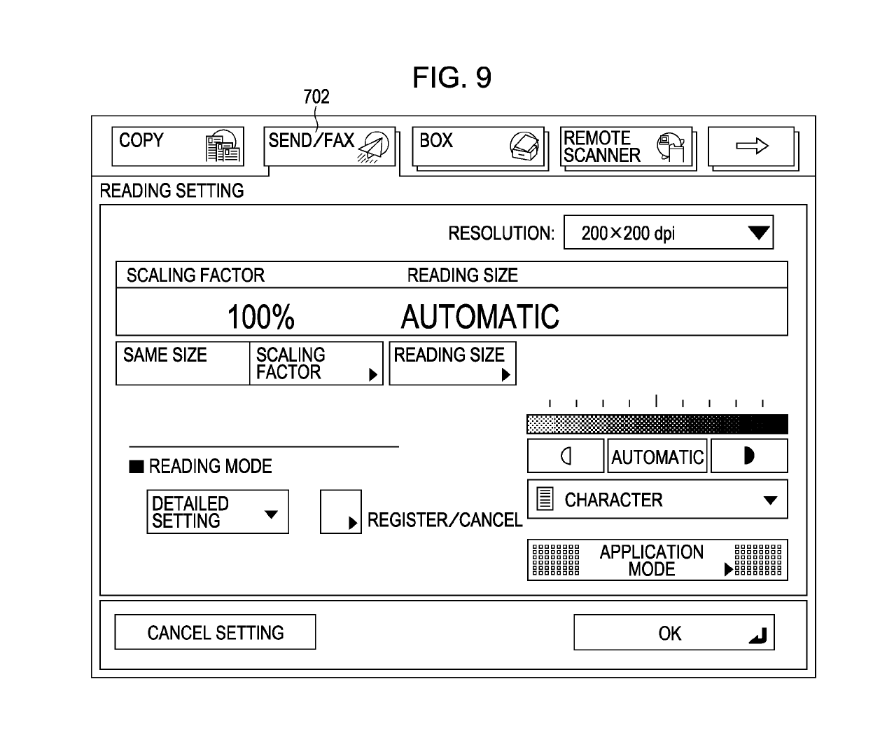

A “reading setting” button 821 is pressed to set details when an image on a document is read and input by using the scanner 170. When the “reading setting” button 821 is pressed, a reading setting screen shown in FIG. 9 is displayed such that the user can set, e.g., the size of a document sheet and resolution. A “sending setting” button 822 is pressed to set details when data is sent in the encrypted form, or when data is sent with an attachment of the password.

A “registration” button 831 and a “verification” button 832 are each pressed when an originality assurance service is utilized. The term “registration” means a process of reading and inputting, e.g., some document by the scanner 170 and registering document information read from that document, as an original, in the originality assurance server 403 connected to the network. The term “verification” means a process of reading, e.g., a document on hand of the user by the scanner 170, comparing document information read from that document, as information to be verified, with the information previously registered as the original, and determining similarity between the verified information and the registered information, thus determining whether the verified information is changed (tampered).

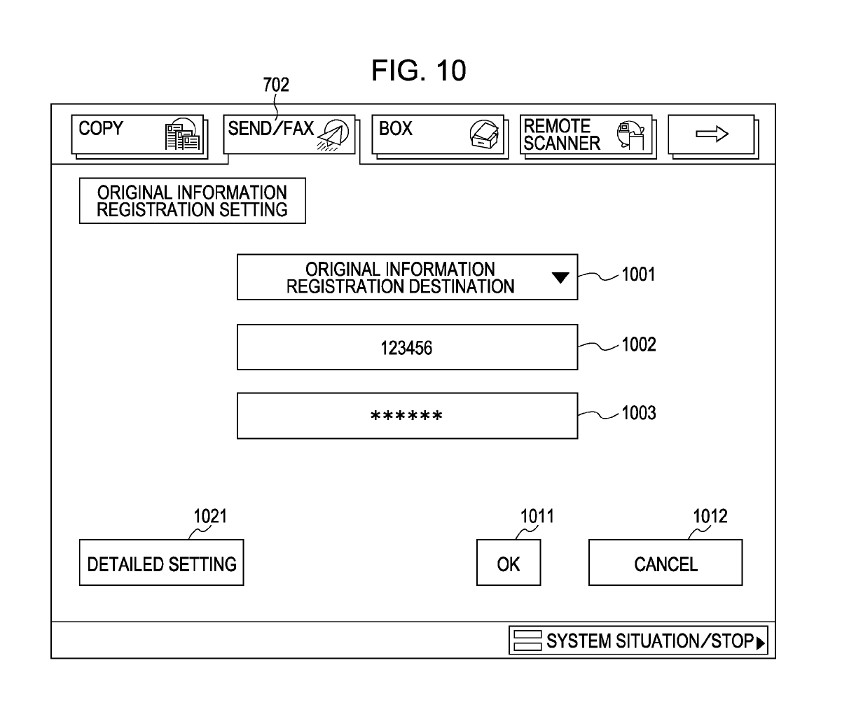

FIG. 10 shows an original information registration setting screen displayed when the “registration” button 831 is pressed. In a registration destination selection box 1001, the user selects the originality assurance server connected to the network, which is displayed in a dropdown list. If the desired originality assurance server is not included in the dropdown list as one of the options, the user can directly input information for specifying the desired apparatus, e.g., an IP address.

In an ID entry box 1002, the user inputs the user ID preset for utilization of the originality assurance service. In a password entry box 1003, the user inputs the password corresponding to the user ID input in the ID entry box 1002. By linking the user authentication for the originality assurance service with the user authentication made on the screen of FIG. 6, the need of additionally inputting the ID and the password on the screen of FIG. 10 is eliminated and the operation is simplified.

The user authentication employing the ID and the password is advantageous, for example, in that a contract user capable of receiving the originality assurance service can be authenticated, or that the original information can be registered together with the user information.

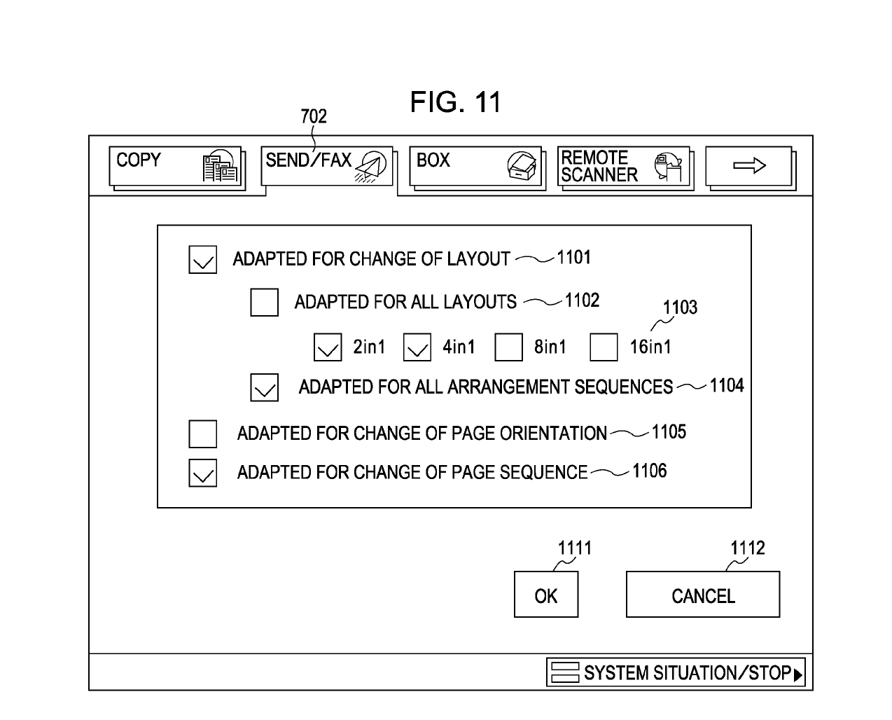

When more detailed setting is made regarding the registration, a “detailed setting” button 1021 is pressed. FIG. 11 shows a screen displayed when the “detailed setting” button 1021 is pressed. On the screen of FIG. 11, the user can designate a plurality of states (such as layout, arrangement sequence, page orientation, and page sequence) in advance, and can instruct the extraction of feature information under various conditions.

It is now assumed, for example, that information for registration is formed by extracting feature information of image data made up of 4 pages. In such a case, when a registration process is executed without designating any of the check boxes displayed on the screen of FIG. 11, one value of feature information is directly extracted and registered from one of 4 pages (4 sheets) in the “1in1” (1 page/1 sheet) layout. As an alternative, the feature information can be extracted per page; namely, four values of feature information can be extracted from 4 pages.

In the case of similarly registering feature information of a document made up of 4 pages, when an “adapted for change of layout” check box 1101 is selected, the feature information is extracted after changing the image data to the layout selected by one of subsequent check boxes 1102-1104. For example, when “2in1” (2 pages/1 sheet) in the check box 1103 is selected, the feature information is further extracted in a state obtained by changing the image data into the “2in1” layout, in addition to the feature information extracted from the image data in the “1in1” layout. Those two values of the feature information can be sent to the originality assurance server 403 and stored therein in a correspondent paired relation.

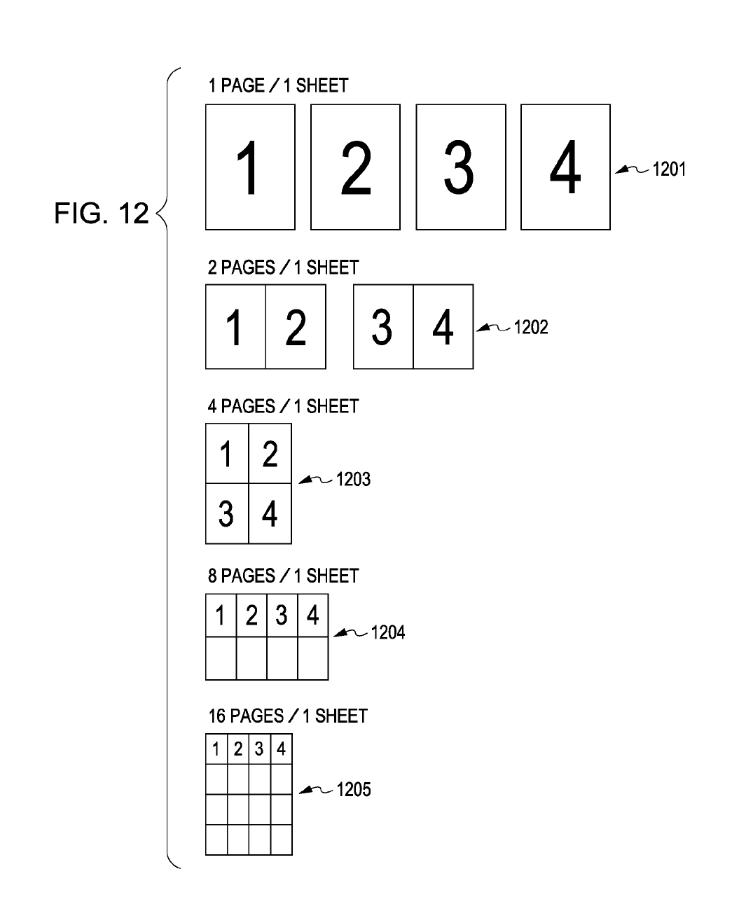

When an “adapted for all layouts” check box 1102 is selected, the feature information can be extracted from all layouts of “1in1”, “2in1”, “4in1”, “8in1” and “16in1” as shown at 1201-1205 in FIG. 12. While only five kinds of layouts are shown, other suitable layouts, such as “6in1” and “9in1”, can be further added. Also, while the feature information in the “1in1” layout is extracted in any selection, the user can be prompted to designate whether the extraction of the feature information in the “1in1” layout is necessary.

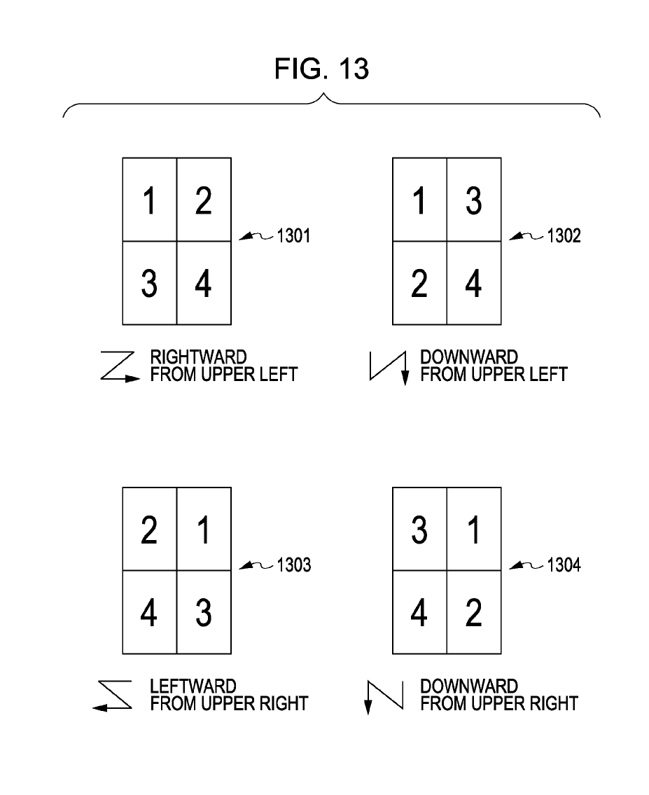

When an “adapted for all arrangement sequences” check box 1104 is selected, the feature information is extracted per arrangement sequence for each layout. FIG. 13 shows examples of the arrangement sequence in the “4in1” layout. As shown at 1301-1304 in FIG. 13, four kinds of arrangements are available in the case of the “4in1” layout. When the “adapted for all arrangement sequences” check box 1104 is selected herein, the feature information is extracted per arrangement sequence, whereby four values of the feature information are obtained. While only an instruction to be adapted for all the arrangement sequences is acceptable in the illustrated example, a modification can also be made so as to designate a particular arrangement sequence (e.g., “downward from upper left”) and to extract only the feature information in the designated arrangement sequence. Such a modification just needs the extraction of only the required feature information and can reduce a load imposed on the processing to extract the feature information.

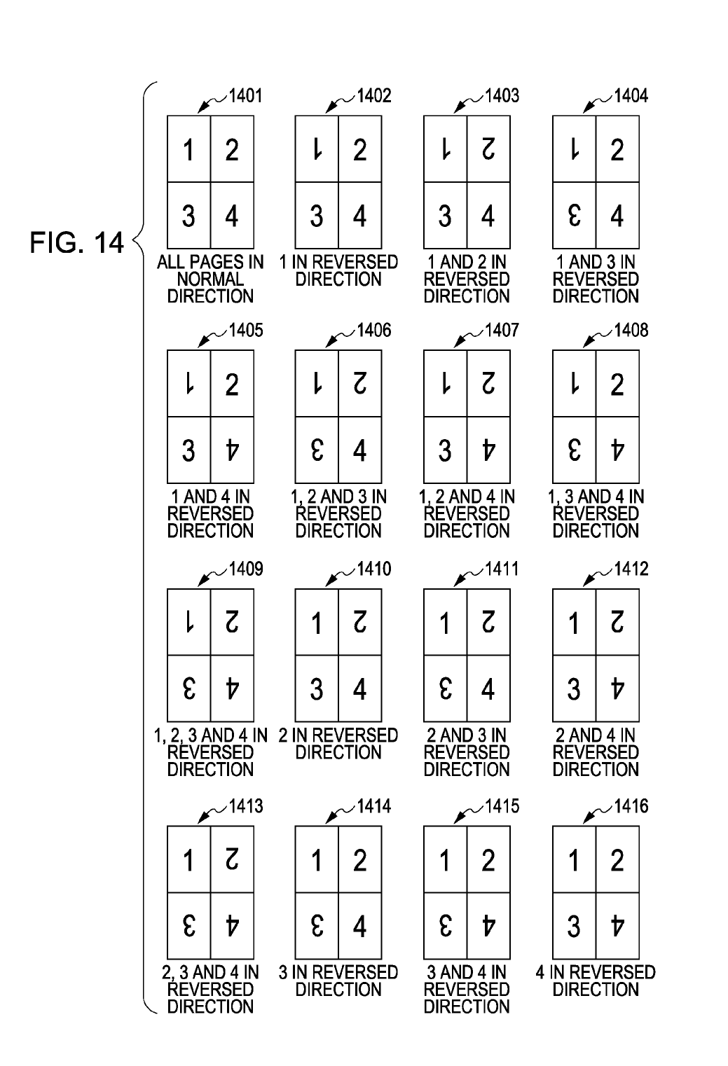

When an “adapted for change of page orientation” check box 1105 is selected, the feature information is extracted in each state where one or more pages in the image data are changed in orientation. FIG. 14 shows examples of the state where the page orientation is changed when the feature information is extracted from a document of 4 pages in the “4in1” layout. As shown at 1401-1416 in FIG. 14, there are sixteen kinds of states in this case. When the “adapted for change of page orientation” check box 1105 is selected herein, the feature information is extracted per state, whereby sixteen values of the feature information are obtained. While only an instruction to be adapted for all the combinations is acceptable in the illustrated example, a modification can also be made so as to designate a particular combination (e.g., “pages 2 and 3 are reversed in direction”) and to extract only the feature information in the designated combination. Such a modification just needs the extraction of only the required feature information and can reduce a load imposed on the processing to extract the feature information.

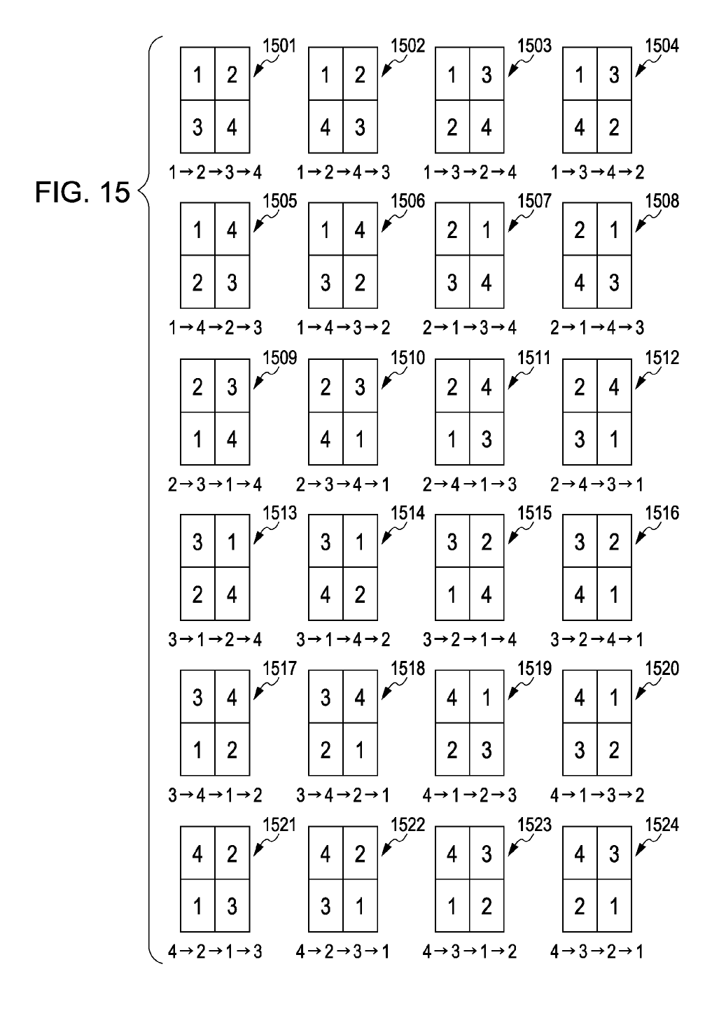

When an “adapted for change of page sequence” check box 1106 is selected, the feature information is extracted in each state where the sequence of pages in the image data is changed. FIG. 15 shows examples of the state where the page sequence is changed when the feature information is extracted from a document of 4 pages in the “4in1” layout with the sequence of “rightward from upper left”. As shown at 1501-1524 in FIG. 15, there are twenty-four kinds of states in this case. When the “adapted for change of page sequence” check box 1106 is selected herein, the feature information is extracted per state, whereby twenty-four values of the feature information are obtained. While only an instruction to be adapted for all the page sequences is acceptable in the illustrated example, a modification can also be made so as to designate a particular page sequence (e.g., “1→3→2→4”) and to extract only the feature information in the designated page sequence. Such a modification just needs the extraction of only the required feature information and can reduce a load imposed on the processing to extract the feature information.

When the above-described detailed settings are input and an OK button 1111 is pressed, the display is returned to the screen of FIG. 10 after prompting the user to confirm the input contents. When a cancel button 1112 is pressed, the input contents are all discarded, followed by return to the screen of FIG. 10.

After completion of the input on the original information registration setting screen (FIG. 10), when the OK button 1011 is pressed and the start button 202 is then pressed, reading of an image on a document to be registered as an original is started by the scanner 170. When a cancel button 1012 is pressed, the input contents are all discarded, followed by return to the “send/fax” basic screen of FIG. 8.

When the reading of the image on the document is completed, the feature information extracted from the input image data is sent, as the information for registration, to the originality assurance server 403 and registered therein. On that occasion, when plural values of feature information are extracted, those values are registered in a correspondent relation. In addition to the feature information, the image data itself can be sent together to and registered in the originality assurance server 403. This modification is more convenient in that the user is not necessarily required to specify the registered data by using a registration ID described later and is able to perform an originality assurance process by specifying the image data with an image search and then using the registered feature information corresponding to the specified image data.

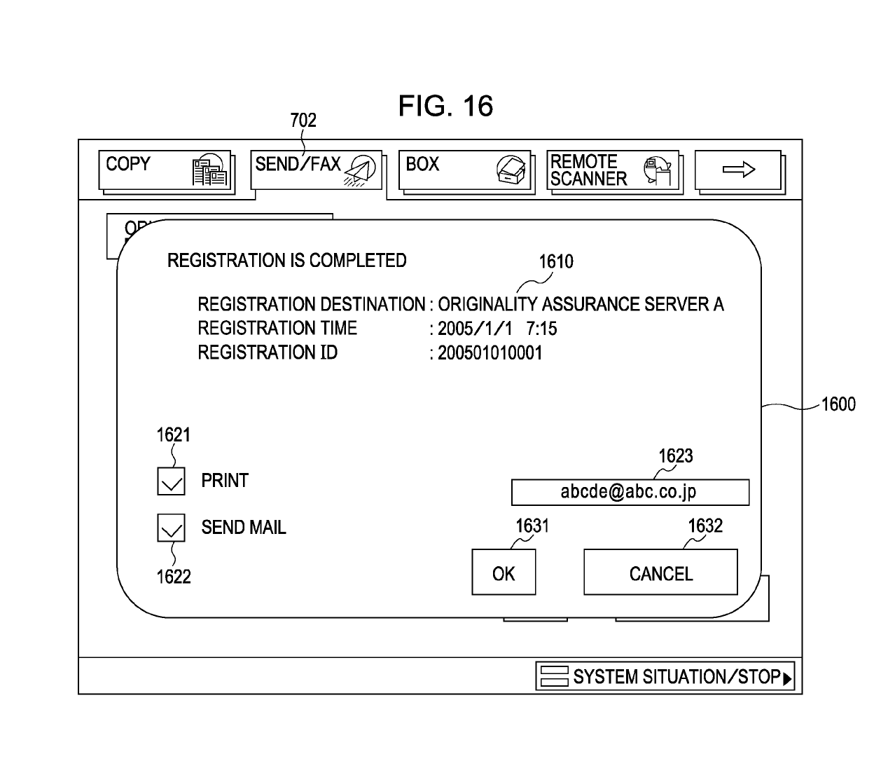

FIG. 16 shows a registration completion screen displayed when the registration into the originality assurance server 403 has been completed. The registration completion screen includes a registered data display window 1600 in which display information 1610 is displayed. The display information 1610 includes, for example, the apparatus name of the registration destination, the registration time, and the registration ID as registered data. Those items of information are used to specify the registered original information when verification is performed.

When the above-described registered data is to be output for printing, the contents of the registered data are printed by the printer 160 by inputting a check in a check box 1621 and pressing an OK button 1631. When the registered data is to be sent by mail, the contents of the registered data are sent to the destination by inputting a check in a check box 1622, inputting a mail address, and pressing the OK button 1631. Thus, by printing or sending the registered data, there is no need of writing down the registered data to be kept at hand. A cancel button 1632 is provided if the user does not want to print or mail the registered data.

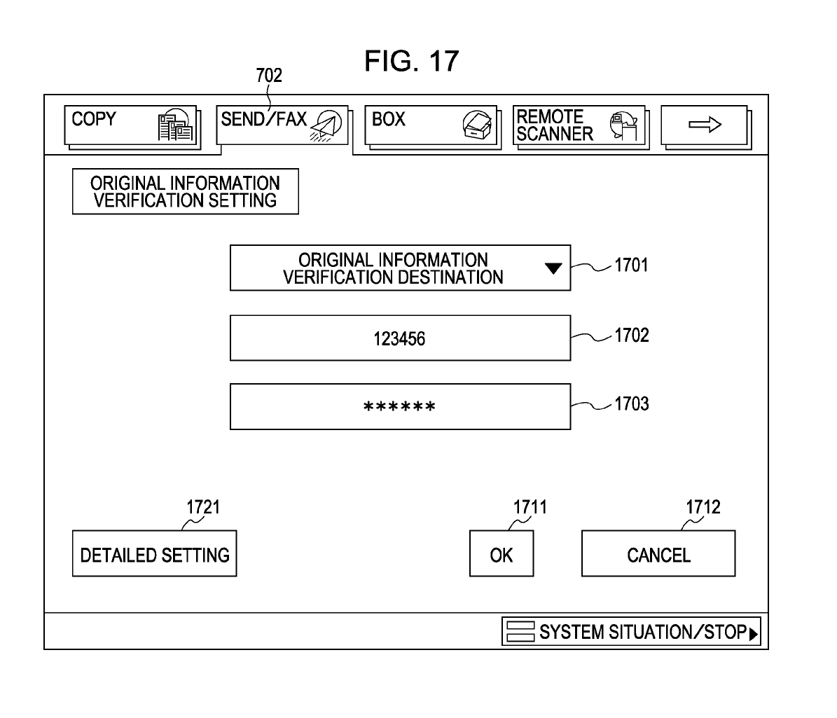

Details of the “verification” process will be described below. FIG. 17 shows an original information verification setting screen displayed when the “verification” button 832 is pressed. In a verification destination selection box 1701, the user selects the originality assurance server connected to the network, which is displayed in a dropdown list. If the desired originality assurance server is not included in the dropdown list as one of the options, the user can directly input information for specifying the desired apparatus, e.g., an IP address.

In an ID entry box 1702 and a password entry box 1703, the user inputs the authentication information for utilization of the originality assurance service as in the original information registration setting screen. Instead of designating the original information verification destination, the desired registration information can be searched for from among a plurality of originality assurance servers connected to the network based on search conditions described later. That method enables the user to verify the image data even if the user forgets the server into which the image data has been registered. Further, instead of specifying the registered information to be verified, a comparison with a plurality of registered data can also be performed by one operation.

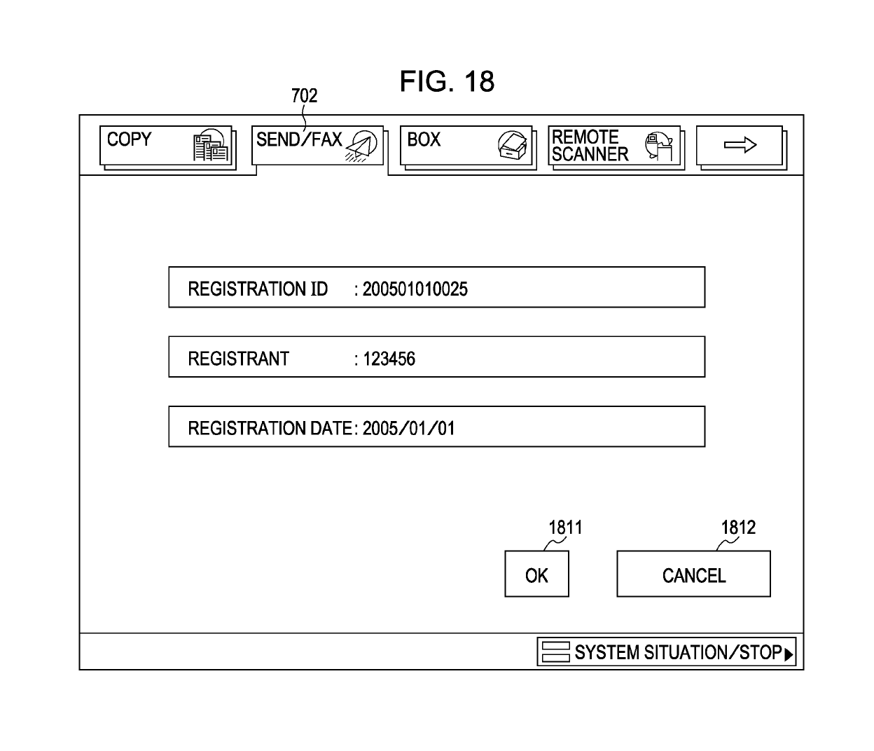

When more detailed setting is made regarding the verification, a “detailed setting” button 1721 is pressed. FIG. 18 shows a screen displayed when the “detailed setting” button 1721 is pressed. When the registration ID, i.e., the information for specifying the registered information to be verified, is known, the registration ID is input. When the registration ID is forgotten or missed, it is also possible to designate the registrant, i.e., the user having registered the original information, who is stored in a correspondent relation to the registered information based on the user authentication information. It is further possible to designate the registration date, i.e., the date on which the original information was registered.

The above-described conditions are used to specify the original information that has already been registered (i.e., the registered information). More specifically, by inputting conditions as required, pressing an OK button 1811 for return to FIG. 17, and then pressing an OK button 1711 in FIG. 17, the registered information matched with the input conditions can be searched for. The original information matched with the input conditions is extracted as one data, for example, when the registration ID is designated, or is extracted as plural data, for example, when only the registration date is designated. When any registered information matched with the search conditions is not found, that result is displayed. Pressing a cancel button 1812 on the screen shown in FIG. 18 returns the screen shown in FIG. 17 without taking any action. Similarly, pressing a cancel button 1712 on the screen shown in FIG. 17 returns to the previous screen shown in FIG. 8 without taking any action.

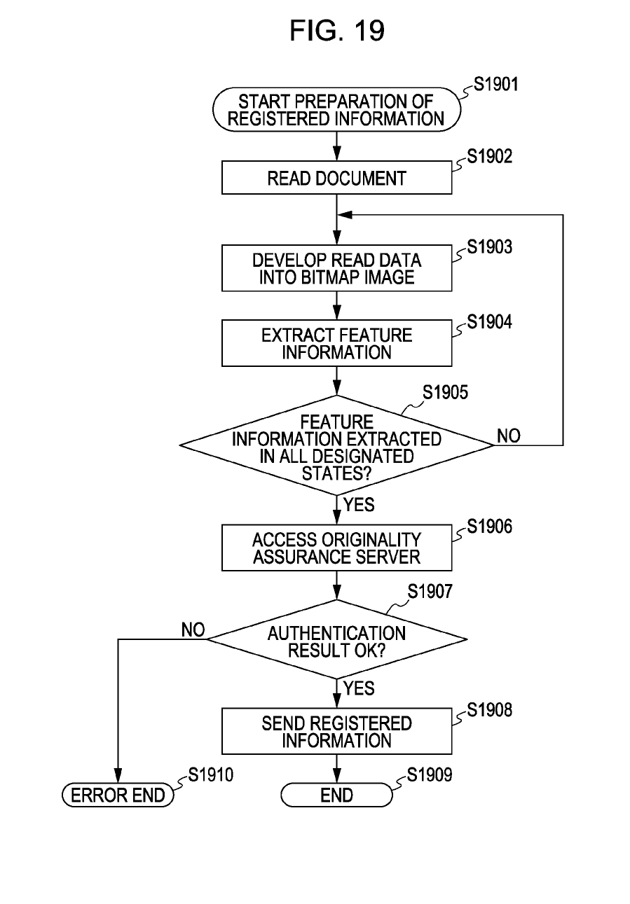

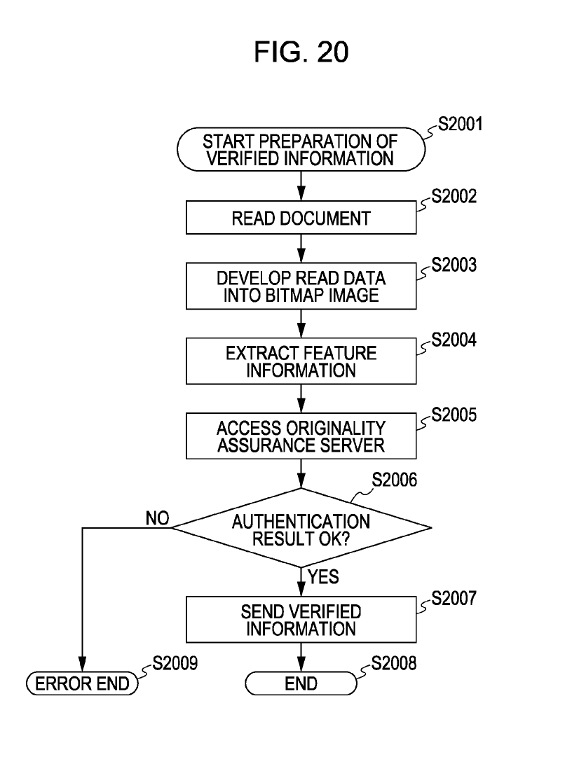

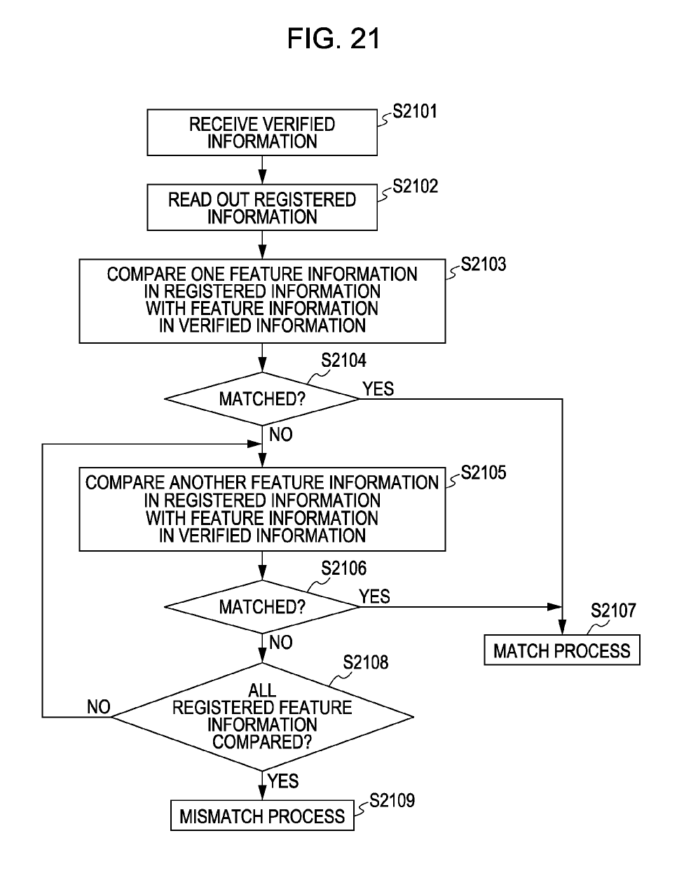

FIGS. 19 and 20 are flowcharts showing the operations controlled by the CPU 125 of the MFP 100 in an easily understandable manner, which are executed in the “registration” and “verification” processes in the first exemplary embodiment described above with reference to FIGS. 8-18. FIG. 21 is a flowchart showing the operations controlled by the CPU 530 of the originality assurance server 403 in an easily understandable manner.

FIG. 19 is a flowchart regarding the operations executed in the “registration” process. First, in S1901, preparation of the registered information is started. S1901 corresponds to the operation of pressing the OK button 1011 in FIG. 10 and then pressing the start button 202. Next, in S1902, an image on a document to be registered as an original is read. Further, read image data is developed into a bitmap image in S1903, and feature information is extracted in S1904.

After extracting the feature information in S1904, the control flow proceeds to S1905 where it is determined whether extraction of the feature information in all designated states is completed. If the determination result in S1905 shows the completion of extraction of the feature information, the control flow proceeds to S1906. On the other hand, if the determination result in S1905 shows that feature information remains not yet extracted, the control flow returns to S1903. Thereafter, a new bitmap image is formed corresponding to a required “state”, and feature information is extracted from the new bitmap image in S1904. As an alternative, when the read image data is first developed into the bitmap image, bitmap data in all required “states” can be formed. The term “state” used herein means the state regarding the “Nin1” layout, the page orientation, the page sequence, etc. For example, the layout can be changed by changing a value of N of the “Nin1” layout.

In S1906, the originality assurance server 403 is accessed based the authentication information input by the user. Then, in S1907, the result of the user authentication made based on the authentication information input by the user is received from the originality assurance server 403 to determine whether the user authentication has succeeded or failed. If the user authentication has failed, the control flow is brought to an “error end” in S1910. If the user authentication has succeeded, the control flow proceeds to S1908 where the prepared registered information is sent to the originality assurance server 403. The control flow is then brought to an end (S1909). Responsive to the end of the “registration” process, the image data of the document of which feature information has been registered can be output for printing as an original.

FIG. 20 is a flowchart regarding the operations executed in the “verification” process. First, in S2001, preparation of the verified information is started. S2001 corresponds to the operation of pressing the OK button 1711 in FIG. 17 and then pressing the start button 202. Next, in S2002, an image on a document to be verified is read.

Further, read image data is developed into a bitmap image in S2003, and feature information is extracted in S2004. Note that, in this first exemplary embodiment, only one kind of feature information is assumed to be extracted in only one state in the step of preparing the verified information.

After extracting the feature information in S2004, the control flow proceeds to S2005 where the originality assurance server 403 is accessed based the authentication information input by the user. Then, in S2006, the result of the user authentication made based on the authentication information input by the user is received from the originality assurance server 403 to determine whether the user authentication has succeeded or failed. If the user authentication has failed, the control flow is brought to an “error end” in S2009. If the user authentication has succeeded, the control flow proceeds to S2007 where the prepared verified information is sent to the originality assurance server 403. The control flow is then brought to an end (S2008).

FIG. 21 is a flowchart regarding the operations executed in the “verification” process made on the originality assurance server side. First, in S2101, the server receives the verified information which was sent from the MFP side in S2007. Then, the server reads out the corresponding registered information in S2102. At that time, when the registration ID is input on the screen of FIG. 18, the registered information corresponding to the input registration ID is read out. When the registration ID is not input on the screen of FIG. 18, the relevant registered information can be searched for, as described above with reference to FIG. 18.

In S2103, the feature information contained in the received verified information is compared with the feature information contained in the read-out registered information. At that time, when plural kinds of feature information are contained in the registered information, a comparison is made between one of the plural kinds of feature information and the feature information contained in the received verified information. In S2104, it is determined whether the comparison result shows a match between respective values of the feature information. If mismatched, the control flow proceeds to S2105.

In S2105, another kind of feature information, which belongs to the plural kinds of feature information contained in the registered information, but which differs from the kind of feature information having been compared in S2103, is compared with the feature information contained in the received verified information. In S2106, it is determined whether the comparison result shows a match between respective values of the feature information. If mismatched, the control flow proceeds to S2108.

If the compared values of the feature information are determined as being matched with each other in S2104 or S2106, the control flow proceeds to S2107 where a “match process” is executed. The term “match process” used herein means, for example, a process of notifying the MFP side of the comparison result that the feature information in the registered information and the feature information in the verified information are matched with each other. The MFP 100 displays the notified matter on the operating panel 140 or prints it by the printer 170. In response to the match between the compared values of the feature information, a certificate certifying that the verified image data is identical to the registered image data, i.e., originality can also be issued.

If the mismatch is determined in S2106, the control flow proceeds to S2108 where it is determined whether all kinds of feature information contained in the registered information have been compared with the feature information in the verified information. If any of the kinds of feature information contained in the registered information remains not yet compared, the control flow returns to S2105 where the remaining feature information is compared with the feature information in the verified information.

If it is determined in S2108 that all of the kinds of feature information contained in the registered information have been compared, the control flow proceeds to S2109 where a “mismatch process” is executed. The term “mismatch process” used herein means, for example, a process of notifying the MFP side of the comparison result that the feature information in the registered information and the feature information in the verified information are mismatched.

According to the first exemplary embodiment described above, by using the originality assurance system including the multi-function printer for reading an image on a document and the originality assurance server in which the original information is registered, the originality assurance can be performed through the step of comparing the previously-registered feature information contained in the registered information with the feature information contained in the verified information as a verification target. Further, when the registered information is prepared, plural kinds of feature information are extracted from the registered information in a plurality of different states, registered in a correspondent relation, and are each compared with the feature information contained in the verified information. As a result, a proper comparison result can be obtained even when any of the layout, the arrangement sequence, the page orientation, the page sequence, etc. of the document differs between when the registered information is prepared and when the verified information is prepared.

### Second Exemplary Embodiment

A second exemplary embodiment of the present invention will be described below. A description of similar components to those in the first exemplary embodiment is not repeated here. The second exemplary embodiment differs from the first exemplary embodiment in that plural kinds of feature information are not extracted when the registered information is prepared, and the feature information is extracted from the verified information in a plurality of different states when the verified information is prepared.

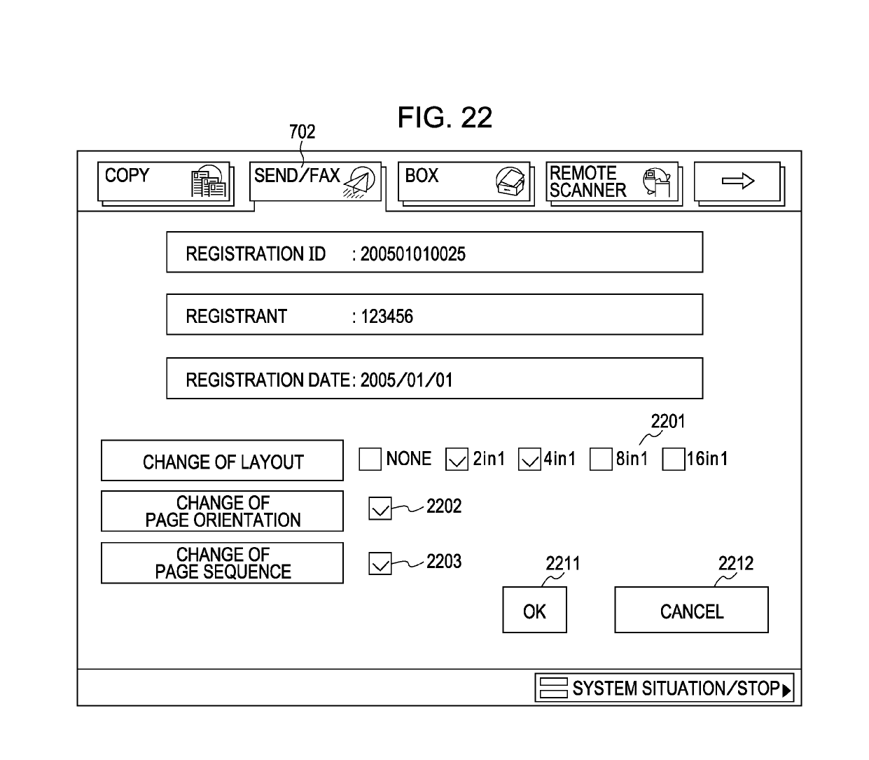

In this second exemplary embodiment, the detailed setting button 1021 in FIG. 10 is not displayed. Stated another way, the detailed setting screen shown in FIG. 11 is not displayed, and the registration process is started by pressing the OK button 1011 and then pressing the start button 202. Also, when the detailed setting button 1721 is pressed on the screen of FIG. 17, a detailed setting screen shown in FIG. 22 is displayed. On the detailed setting screen of FIG. 22, information regarding the document to be verified can be input in addition to the above-described information, i.e., the registration ID, the registrant, and the registration date. Thus, the user can input information regarding the state (e.g., layout, orientation of each page, and page sequence) of the document to be verified.

When the layout of the document to be verified is changed in comparison with the state of the document when it is registered, a “layout change” check box 2201 is used to input such a change. For example, when the document at the time of registration is in the “1in1” layout and the document at the time of verification is in the “2in1” layout information, “2in1” is selected as shown. With that selection, when the verified information is prepared, the feature information is extracted after converting, to the “1in1” layout, data that is obtained by reading the document in the “2in1” layout. Herein, the user can select one or more layouts which are possibly changed. Instead of prompting the user to make a selection as described above, respective values of plural layouts can be extracted in an automatic manner.

A “page orientation change” check box 2202 and a “page sequence change” check box 2203 are selected respectively when the page orientation in a document is changed and when the page sequence in a document is changed. With the selection of those check boxes 2202 and 2203, when the verified information is prepared, the feature information is extracted for all the combinations of the page orientations and all the states of the page sequence as described above in connection with the “adapted for change of page orientation” check box 1105 and the “adapted for change of page sequence” check box 1106 in the first exemplary embodiment. An OK button 2211 is provided for changing the settings as indicated on the screen shown in FIG. 22. A cancel button 2212 is provided for returning to the previous screen without changing any of the settings.

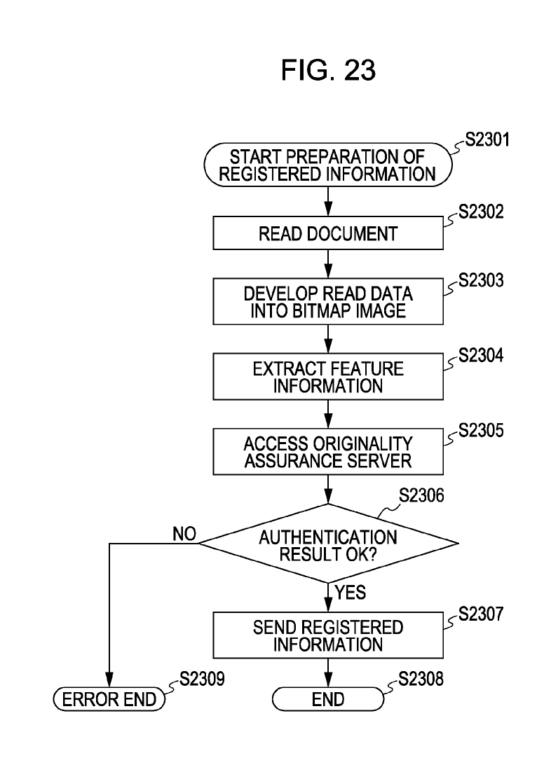

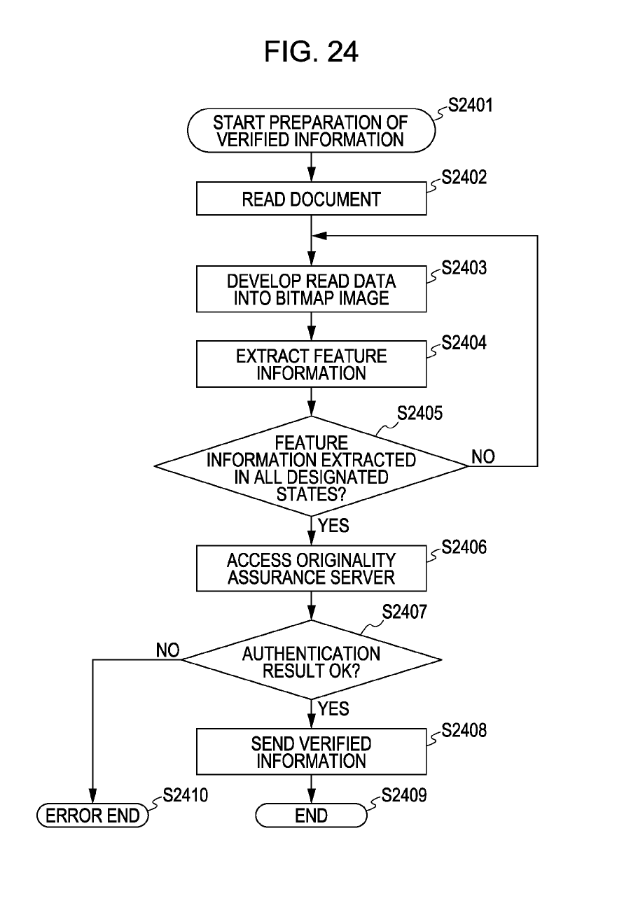

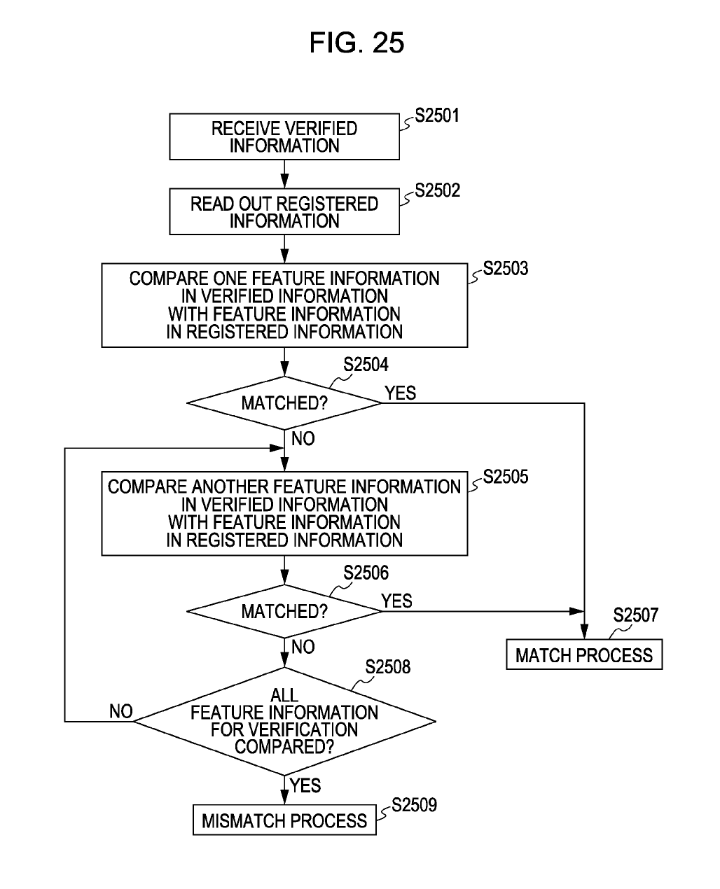

FIGS. 23 and 24 are flowcharts showing the operations controlled by the CPU 125 of the MFP 100 in an easily understandable manner, which are executed in the “registration” and “verification” processes in the second exemplary embodiment. FIG. 25 is a flowchart showing the operations controlled by the CPU 530 of the originality assurance server 403 in an easily understandable manner.

FIG. 23 is a flowchart regarding the operations executed in the “registration” process. Since S2301 to S2309 in this flowchart are similar to S1901 to S1904 and S1906 to S1910, shown in FIG. 19, in the first exemplary embodiment, a description of those steps is not repeated here. The flowchart of FIG. 23 does not include the step of determining whether the feature information has been extracted in all the designated states, as in S1905 of FIG. 19. Thus, in this second exemplary embodiment, only one kind of feature information is extracted and sent.

FIG. 24 is a flowchart regarding the operations executed in the “verification” process. Since S2401 to S2404 and S2406 to S2410 in this flowchart are similar to the corresponding steps (S2001 to S2009), shown in FIG. 20, in the first exemplary embodiment, a description of those steps is not repeated here. Unlike the first exemplary embodiment in which only one kind of feature information is extracted, it is determined in S2405 whether the feature information has been extracted in all the designated states. If there remains the designated state for which the feature information is not yet extracted, the control flow returns to S2403, and if the feature information has been completely extracted in all the designated states, the control flow proceeds to S2406. Thus, in this second exemplary embodiment, the feature information is extracted and sent for each of the designated states.

FIG. 25 is a flowchart regarding the operations executed in the “verification” process made on the originality assurance server side. First, in S2501, the server receives the verified information which was sent from the MFP side in S2408. Then, the server reads out the corresponding registered information in S2502. At that time, when the registration ID is input on the screen of FIG. 18, the registered information corresponding to the input registration ID is read out. When the registration ID is not input on the screen of FIG. 18, the relevant registered information can be searched for, as described above with reference to FIG. 18.

In S2503, the feature information contained in the received verified information is compared with the feature information contained in the read-out registered information. At that time, when plural kinds of feature information are contained in the verified information, a comparison is made between one of the plural kinds of feature information and the feature information contained in the read-out registered information. In S2504, it is determined whether the comparison result shows a match between respective values of the feature information. If mismatched, the control flow proceeds to S2505.

In S2505, another kind of feature information, which belongs to the plural kinds of feature information contained in the verified information, but which differs from the kind of feature information having been compared in S2503, is compared with the feature information contained in the read-out registered information. In S2506, it is determined whether the comparison result shows a match between respective values of the feature information. If mismatched, the control flow proceeds to S2508.

If the compared values of the feature information are determined as being matched with each other in S2504 or S2506, the control flow proceeds to S2507 where a “match process” is executed. The term “match process” used herein means, for example, a process of notifying the MFP side of the comparison result that the feature information in the registered information and the feature information in the verified information are matched with each other. The MFP 100 displays the notified matter on the operating panel 140 or prints it by the printer 170. In addition, a certificate certifying the match between the compared values of the feature information can also be issued.

If the mismatch is determined in S2506, the control flow proceeds to S2508 where it is determined whether all kinds of feature information contained in the verified information have been compared with the feature information in the registered information. If any of the kinds of feature information contained in the verified information remains not yet compared, the control flow returns to S2505 where the remaining feature information is compared with the feature information in the registered information.

If it is determined in S2508 that all of the kinds of feature information contained in the verified information have been compared, the control flow proceeds to S2509 where a “mismatch process” is executed. The term “mismatch process” used herein means, for example, a process of notifying the MFP 100 side of the comparison result that the feature information in the registered information and the feature information in the verified information are mismatched.

While the above description is made as deciding the layout(s) for extraction of the feature information in accordance with a user's instruction when the verified information is prepared, the layout(s) for extraction of the feature information can be automatically decided by detecting the number of pages contained in the read document. Such a modification can eliminate the necessity of manually designating the layout(s) and is convenient for the user.

According to the second exemplary embodiment described above, by using the originality assurance system including the multi-function printer for reading an image on a document and the originality assurance server in which the original information is registered, the originality assurance can be performed through the step of comparing the previously-registered feature information contained in the registered information with the feature information contained in the verified information as a verification target. Further, when the verified information is prepared, plural kinds of feature information are extracted respectively from the verified information in a plurality of different states, sent to the originality assurance server, and are each compared with the feature information contained in the registered information. As a result, a proper comparison result can be obtained even when any of the layout, the arrangement sequence, the page orientation, the page sequence, etc. of the document differs between when the registered information is prepared and when the verified information is prepared.

### Third Exemplary Embodiment

A third exemplary embodiment of the present invention will be described below. A description of similar components to those in the first and second exemplary embodiments is not repeated here. The third exemplary embodiment differs from the first and second exemplary embodiments in that, when sending the registered information, the registered information is sent together with information indicating the state of a document from which was extracted each kind of the feature information contained in the registered information. Another different point is that the originality assurance server manages the feature information contained in the registered information together with the information indicating the state of the document at the time when the feature information was extracted. Still another different point is that when the verified information is prepared, the user designates the state of the document and the verified information is sent to the originality assurance server together with information indicating the state of the document.

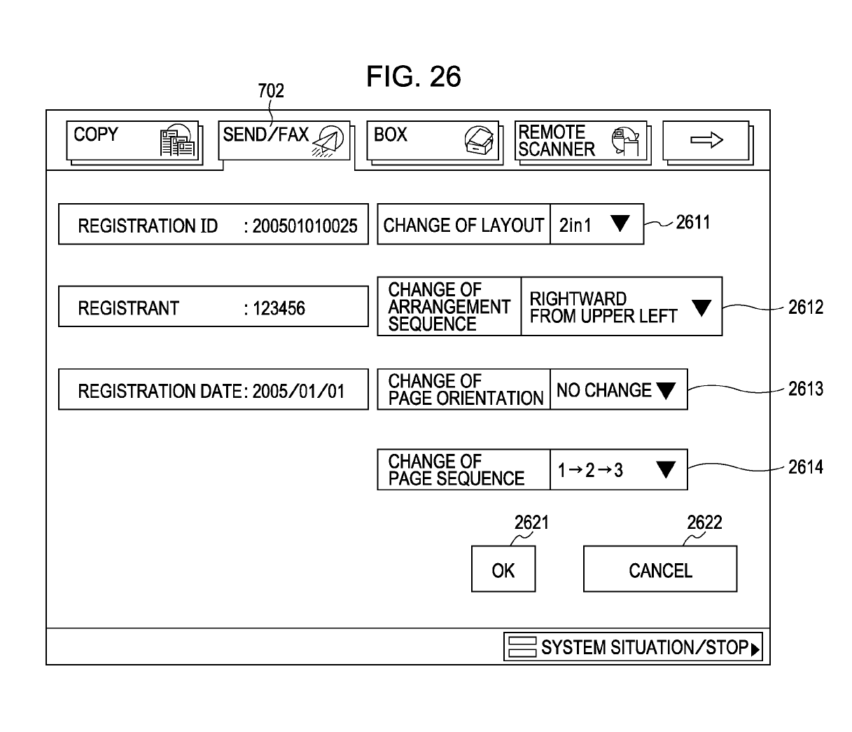

In this third exemplary embodiment, when the detailed setting button 1721 on the screen of FIG. 17 is pressed, a detailed setting screen shown in FIG. 26 is displayed. On the detailed setting screen of FIG. 26, information regarding the document to be verified can be input in addition to the above-described information for specifying the registration ID, the registrant, and the registration date. Thus, the user can input information regarding the state (e.g., layout, orientation of each page, and page sequence) of the document to be verified.

Referring to FIG. 26, in entry boxes 2611-2614, the user can select the document state (layout, arrangement sequence, page orientation, and page sequence) from options included in a dropdown list. While the illustrated example allows the user to select one option for each item, the screen configuration can be modified such that a plurality of options can be selected for each item, or the selection is not allowed for some item. Thus, even when the user does not correctly know the state of the document to be verified, the user can designate the document state by utilizing information known as far as possible. Pressing an OK button 2621 changes the document state according to the settings and returns to the previous screen shown in FIG. 17. Pressing a cancel button returns to the previous screen shown in FIG. 17 without changing the document state.

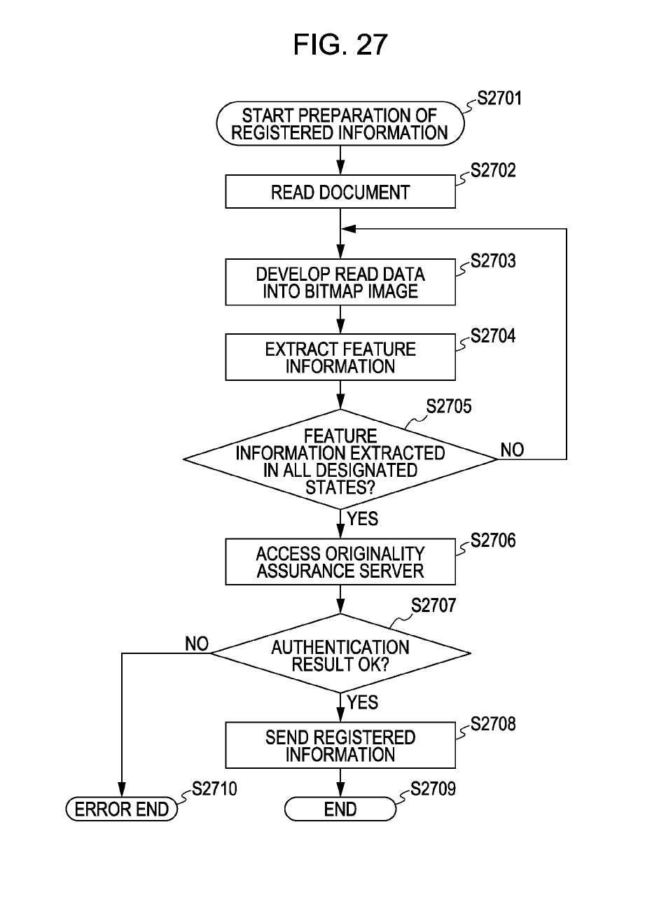

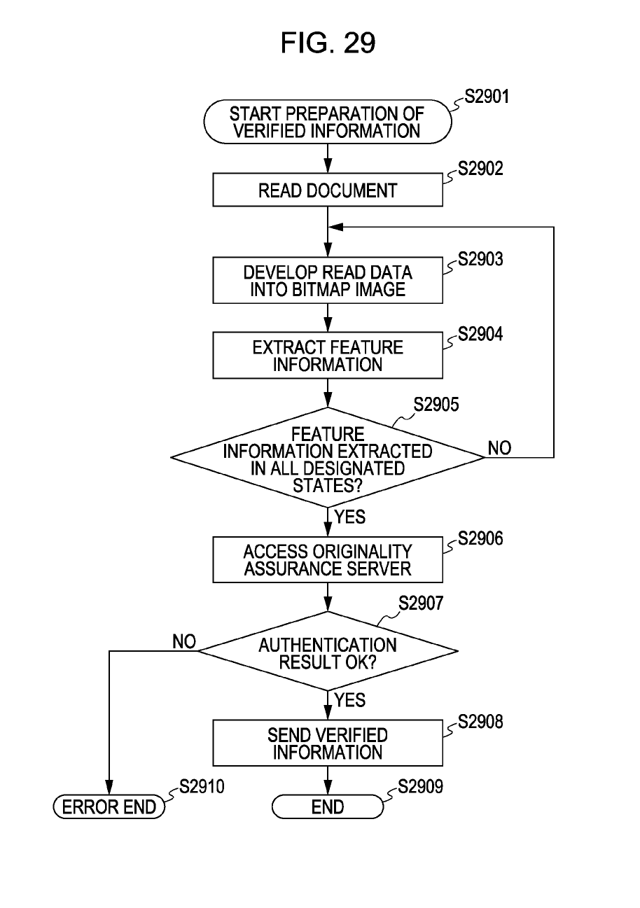

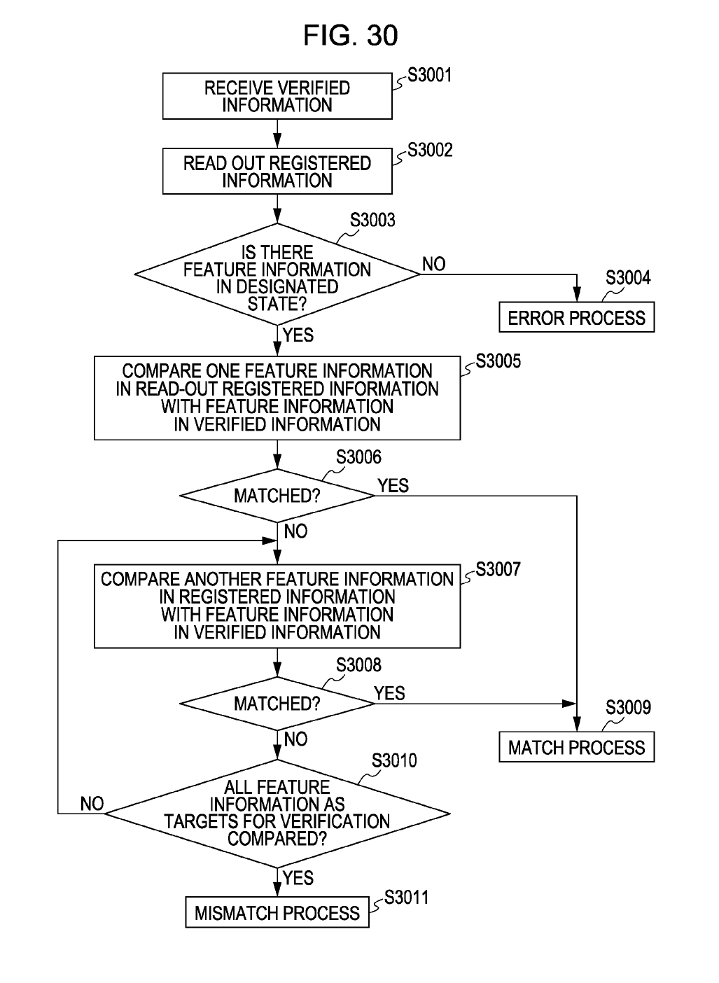

FIGS. 27 and 29 are flowcharts showing the operations controlled by the CPU 125 of the MFP 100 in an easily understandable manner, which are executed in the “registration” and “verification” processes in the third exemplary embodiment. FIG. 30 is a flowchart showing the operations controlled by the CPU 530 of the originality assurance server 403 in an easily understandable manner.

FIG. 27 is a flowchart regarding the operations executed in the “registration” process. Since S2701 to S2707 and S2709 to S2710 in this flowchart are similar respectively to S1901 to S1907 and S1909 to S1910, shown in FIG. 19, in the first exemplary embodiment, a description of those steps is not repeated here. In S2708, not only the registered information is sent as in S1908, but also information indicating the document state (e.g., layout, orientation of each page, and page sequence) at the time of extraction of the feature information is additionally sent together.

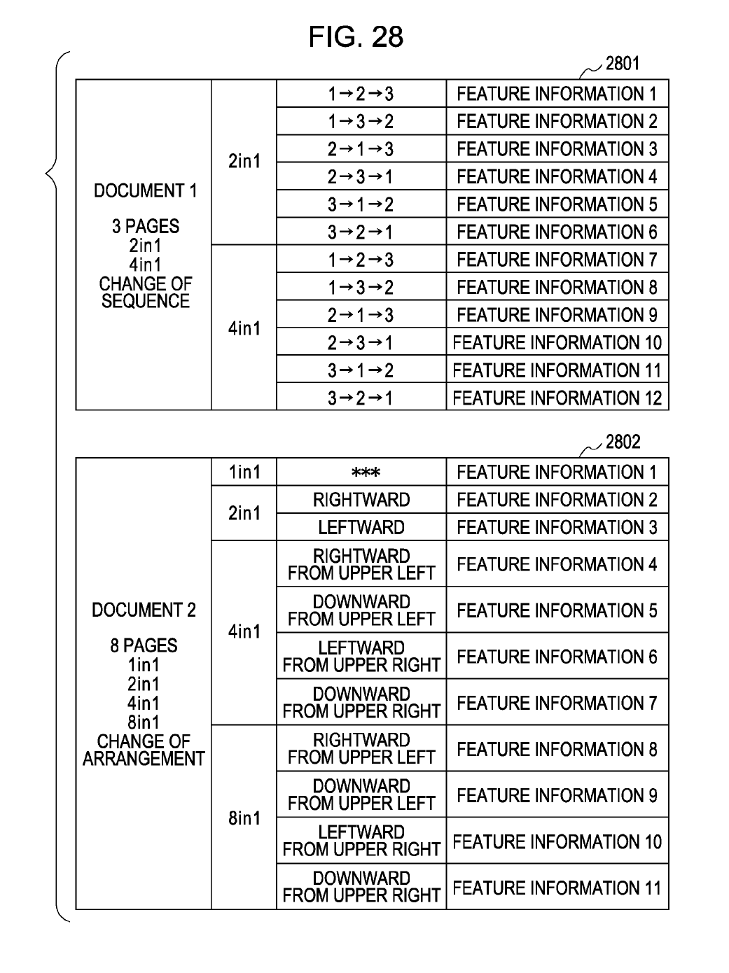

FIG. 28 shows one example of a feature information management table 570 prepared in the originality assurance server 403. The feature information contained in the registered information sent in S2708 and the information indicating the document state at the time of extraction of the feature information are managed in the form of a management table shown in FIG. 28. In the illustrated example, a table 2801 manages 12 values of feature information which were extracted from the “document 1” of 3 pages to be adaptable for change of page sequence for each of the “2in1” and “4in1” layouts. In the illustrated example, a table 2802 manages 11 values of feature information which were extracted from the “document 2” of 8 pages to be adaptable for change of arrangement sequence for each of the “1in1”, “2in1”, “4in1” and “8in1” layouts.

FIG. 29 is a flowchart regarding the operations executed in the “verification” process. Since S2901 to S2907 and S2909 to S2910 in this flowchart are similar respectively to S2401 to S2407 and S2409 to S2410, shown in FIG. 24, in the second exemplary embodiment, a description of those steps is not repeated here. In S2908, not only the verified information is sent as in S2408, but also information indicating the document state at the time of extraction of the feature information is additionally sent together. More specifically, the information input in the entry boxes 2611-2614 on the screen of FIG. 26 is additionally sent.

FIG. 30 is a flowchart regarding the operations executed in the “verification” process made on the originality assurance server side. First, in S3001, the server receives the verified information which was sent from the MFP side in S2908. Then, the server reads out the corresponding registered information in S3002. At that time, when the registration ID is input on the screen of FIG. 18, the registered information corresponding to the input registration ID is read out. When the registration ID is not input on the screen of FIG. 18, the relevant registered information can be searched for, as described above with reference to FIG. 18.

In S3003, it is determined whether the read-out registered information includes the feature information extracted in the same state as that specified by the user inputting conditions in the entry boxes 2611-2614 of FIG. 26. If there is no feature information in match with the input conditions, the control flow proceeds to S3004 in which an “error process” is executed. The term “error process” used herein means, for example, a process of notifying the fact that the feature information in match with the input conditions on the MFP side is not stored on the server side, or notifying the user of a list of the “states” in each of which was extracted the feature information.

If it is determined in S3003 that there is feature information matching the input user conditions, in S3005, the feature information contained in the received verified information is compared with the feature information which is contained in the read-out registered information and which is one of them extracted in the same document states as those designated. In S3006, it is determined whether the comparison result shows a match between respective values of the feature information. If mismatched, the control flow proceeds to S3007.

In S3007, another kind of feature information, which is contained in the registered information and is one of them extracted in the same document states as those designated, but which differs from the feature information having been compared in S3005, is compared with the feature information contained in the verified information. In S3008, it is determined whether the comparison result shows a match between respective values of the feature information. If mismatched, the control flow proceeds to S3010.

If the compared values of the feature information are determined as being matched with each other in S3006 or S3008, the control flow proceeds to S3009 where a “match process” is executed. The term “match process” used herein means, for example, a process of notifying the MFP side of the comparison result that the feature information in the registered information and the feature information in the verified information are matched with each other. In addition, a certificate certifying the match between the compared values of the feature information can also be issued.

If the mismatch is determined in S3008, the control flow proceeds to S3010 where it is determined whether all values of the feature information contained in the registered information and extracted in the same document states as those designated have been compared with the feature information in the verified information. If any feature information satisfying those conditions remains not yet compared, the control flow returns to S3007 where the remaining feature information is compared with the feature information in the verified information.

If it is determined in S3010 that all values of the feature information contained in the registered information and extracted in the same document states as those designated have been compared, the control flow proceeds to S3011 where a “mismatch process” is executed. The term “mismatch process” used herein means, for example, a process of notifying the MFP side of the comparison result that the feature information in the registered information and the feature information in the verified information are mismatched.

Corresponding to the notification of the “match” or the “mismatch” from the server, the MFP can display the comparison result on the liquid crystal panel section 201 or can output it for printing. This enables the comparison result to be easily notified to the user.

While the above description is made as specifying the layout of the document in accordance with a user's instruction when the verified information is prepared, the layout of the document can be automatically specified by detecting the number of pages contained in the read document. Such a modification can eliminate the necessity of manually designating the layout of the document and is convenient for the user.

According to the third exemplary embodiment described above, by using the originality assurance system including the multi-function printer for reading an image on a document and the originality assurance server in which the original information is registered, the originality assurance can be performed through the step of comparing the previously-registered feature information contained in the registered information with the feature information contained in the verified information as a verification target. Further, when the verified information is sent, the MFP 100 sends the verified information with addition of the information indicating the document state. The originality assurance server reads out the stored feature information based on the information indicating the document state and makes a comparison using the read-out feature information. In the verification process, the feature information contained in the verified information is compared with only the feature information which is contained in the registered information and which was extracted in the same document state as that designated. As a result, a proper comparison result can be obtained even when any of the layout, the arrangement sequence, the page orientation, the page sequence, etc. of the document differs between when the registered information is prepared and when the verified information is prepared.

### Fourth Exemplary Embodiment

A fourth exemplary embodiment of the present invention will be described below. A description of similar components to those in the first, second and third exemplary embodiments is not repeated here. The fourth exemplary embodiment differs from the first, second and third exemplary embodiments in that when the registered information and the verified information are prepared, plural kinds of feature information are not extracted. Another different point is that when the MFP 100 receives the notification of “mismatch” from the originality assurance server as the comparison result of the feature information, the verified information is prepared again by newly extracting the feature information in a difference state of the document.

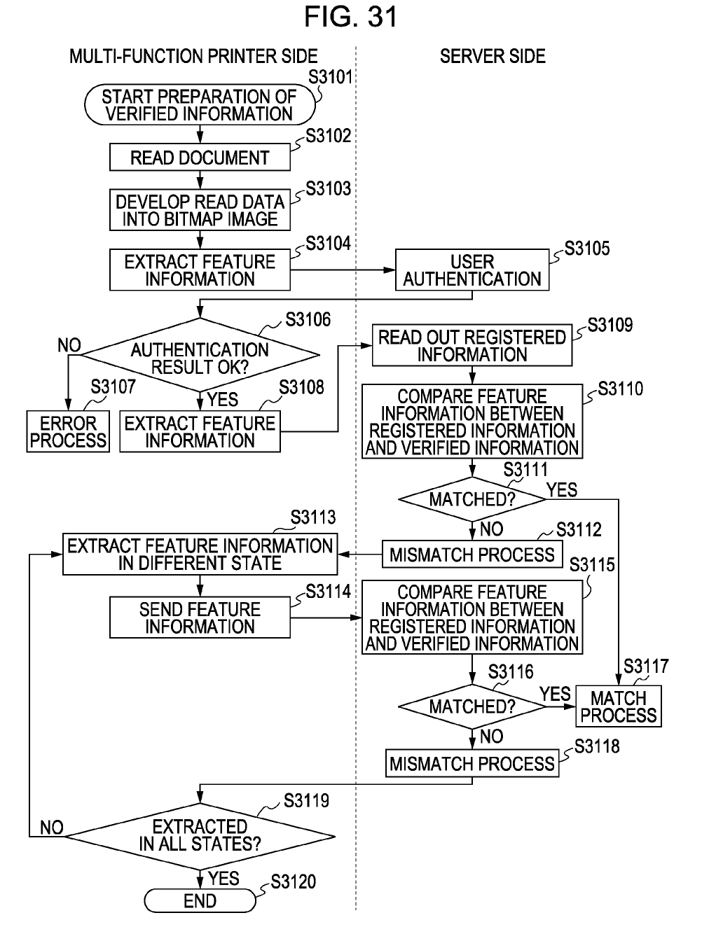

FIG. 31 is a flowchart showing the operations controlled by both the CPU 125 of the MFP 100 and the CPU 530 of the originality assurance server 403 in an easily understandable manner, which are executed in the “verification” process in the fourth exemplary embodiment. Note that the operations executed in the “registration” process are the same as those in the second exemplary embodiment and a description thereof is not repeated here.

First, in S3101 to S3104, the feature information is extracted in a similar manner to that in the first exemplary embodiment (see FIG. 20). Then, the server side is accessed. In S3105, the originality assurance server 403 executes the process of user authentication and notifies the result of the user authentication to the MFP side. Based on the result notified from the server side, the MFP 100 determines in S3106 whether the error process is executed in S3107 or the feature information is sent in S3108.

If the feature information is sent in S3108 from the MFP side, the server reads out the corresponding registered information in S3109 and compares the feature information contained in the read-out registered information with the feature information contained in the received verified information in S3110. Then, it is determined in S3111 whether the comparison result shows that respective values of the feature information are matched with each other. If matched, the control flow proceeds to S3117 where the “match process” is executed, and if mismatched, the control flow proceeds to S3112 where the “mismatch process” is executed. In the “match process” and the “mismatch process” herein, the respective comparison results are notified to the MFP 100 as in the first, second and third exemplary embodiments described above.

When the “mismatch process” is executed in S3112, the MFP 100 receives the notified result and newly extracts, in S3113, the feature information in a state differing from the state in which the feature information was extracted in S3104. At that time, the feature information extracting section 115 forms bitmap image data in a new “state” from the data that was read from the document and stored in S3102, and extracts the feature information from the formed bitmap image data. Accordingly, there is no need of reading the document again.

In S3114, the feature information extracted in S3113 is sent to the server side. The server receives the sent feature information and compares it, in S3115, with the feature information contained in the registered information that was read out in S3109. Then, it is determined in S3116 whether the comparison result shows that respective values of the feature information are matched with each other. If matched, the control flow proceeds to S3117 where the “match process” is executed, and if mismatched, the control flow proceeds to S3118 where the “mismatch process” is executed.

When the “mismatch process” is executed in S3118, the MFP 100 receives the notified result and determines in S3119 whether the feature information has been extracted in all states as information for the verification. The term “all states” used herein means all states which are formable as combinations of the preset layout, arrangement sequence, page orientation, and page sequence. If there remains the “state” in which the feature information is not yet extracted, the control flow returns to S3113 where the feature information is newly extracted in the relevant “state”. Then, the newly extracted feature information is subjected to a comparison on the server side in a similar manner. If it is determined in S3119 that the feature information has been completely extracted in all the “states”, the control flow proceeds to S3120 and is brought to an end.

While in the first, second and third exemplary embodiments the comparison result is displayed on the MFP side, e.g., on the liquid crystal panel section 201, in response to the notification of “match” or “mismatch” from the server side, the notification of “mismatch” is displayed in this fourth exemplary embodiment corresponding to the “end” process of S3120. Stated another way, in a stage of the “mismatch process” of S3112, it is not yet completely decided that the verified information is mismatched from the registered information. Therefore, the notification of “mismatch” is not performed in S3112, but it is performed corresponding to the “end” process of S3120.

According to the fourth exemplary embodiment described above, by using the originality assurance system including the multi-function printer for reading an image on a document and the originality assurance server in which the original information is registered, the originality assurance can be performed through the step of comparing the previously-registered feature information contained in the registered information with the feature information contained in the verified information as a verification target. Further, when the feature information contained in the registered information and the feature information contained in the verified information are mismatched as a result of the comparison, the feature information is extracted again in a different state of the verified information and is subjected to a comparison as information for the verification. As a result, a proper comparison result can be obtained even when the document state differs between when the registered information is prepared and when the verified information is prepared. Further, in comparison with the first, second and third exemplary embodiments, the number of times of extracting the feature information can be reduced and the time required for the extraction process can be shortened correspondingly.

The present invention is not limited to the originality assurance system having the above-described configuration. While in the first, second and third exemplary embodiments the original information is registered in the originality assurance server connected to the multi-function printer via the network, that function of the originality assurance server can be incorporated in the multi-function printer. With such a modification, the originality assurance can be simply performed even when the network environment is not sufficiently equipped, and a higher level of security can be obtained because of no necessity of sending even the feature information to the network.

Further, the present invention is not limited to the system for providing the originality assurance service, and it can also be applied to, e.g., the service of storing electronic documents and a document management server with the function of registering desired documents therein.

In addition, the present invention is not limited to the case where the feature information is extracted from data input by using the scanner 170. For example, it is possible to extract the feature information, as information for registration and information for verification, from image data stored in a storage area, e.g., the memory 180, and to perform the registration and verification processes using the extracted feature information.

### Other Exemplary Embodiments

The exemplary embodiments have been described in detail above, but the present invention can be practiced in the form of, e.g., a system, an apparatus, a method, a program, or a storage medium (recording medium). In practice, the present invention can be applied to a system constituted by a plurality of units, or to an apparatus constituted by a single unit.

Further, the present invention can be practiced as follows. A software program for realizing the functions of any of the above-described exemplary embodiments (i.e., a program corresponding to the illustrated flowchart for each of the exemplary embodiments) is directly or remotely supplied to a system or an apparatus. Then, a computer in the system or the apparatus reads and executes the supplied program code.

Accordingly, the program code installed in the computer to realize functions and processing executed in the present invention also serves to realize the present invention. In other words, the present invention involves the program code itself for realizing the functions and the processing executed in the present invention.

In the above case, the program can be any of various forms, e.g., object code, a program executed by an interpreter, and script data supplied to an OS, so long as the program has the required functions.

Recording media for providing the program can be, e.g., a floppy disk, a hard disk, an optical disk, a magneto-optical (MO) disk, CD-ROM, CD-R, CD-RW, a magnetic tape, a nonvolatile memory card, ROM, DVD (DVD-ROM and DVD-R), etc.

Further, the program can be supplied by downloading, to a recording medium such as a hard disk, from a home page on the Internet by using a browser in a client computer. More specifically, the program can be supplied through the steps of connecting the client computer to the homepage and downloading the computer program of the present invention in itself or a file, which contains the computer program in compressed form and which has the automatic installing function, to the recording medium from the connected homepage. As another method, program code constituting the program of the present invention can be divided into a plurality of files, and those files can be downloaded from different homepages. In other words, the present invention involves a WWW server for downloading, to a plurality of users, a program file which realizes the functions and the processing executed in the present invention with a computer.

Alternatively, the program can also be supplied as follows. The program of the present invention is encrypted and stored in a storage medium, e.g., CD-ROM, for distribution to users. The user who satisfies predetermined conditions is allowed to download key information necessary for decryption from a homepage via the Internet. The user decrypts and executes the encrypted program by using the downloaded key information, thus installing the program in the computer.

The functions of the above-described exemplary embodiment are realized with the computer executing the read program. Moreover, the present invention involves the case where the functions of the above-described exemplary embodiment are realized in such a manner that, for example, an OS operating on the computer executes a part or the whole of actual processing in accordance with instructions from the read program.

In addition, the present invention involves the case where the functions of the above-described exemplary embodiment are realized as follows. The program read from a storage medium is written in a memory provided on a function expansion board inserted in a computer or in a memory incorporated in a function expansion unit connected to the computer. Then, a CPU or the like provided on the function expansion board or incorporated in the function expansion unit executes a part or the whole of actual processing in accordance with instructions from the read program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2006-144353 filed May 24, 2006, which is hereby incorporated by reference herein in its entirety.

What is claimed is:

1. An information processing apparatus comprising:
an input unit configured to input image data;
an extraction unit configured to extract feature information from the image data;
a changing unit configured to change a layout of first image data input by the input unit;
a memory unit configured to store at least first feature information and second feature information in a correspondent relation, the first feature information and the second feature information being respectively extracted by the extraction unit from at least two different image data contained in plural kinds of image data having a plurality of layouts based on the first image data, the plural kinds of image data including at least the first image data and second image data of which layout is changed by the changing unit based on the first image data;
a comparison unit configured to compare third feature information extracted from third image data by the extraction unit with the first feature information and the second feature information both stored in the memory unit; and
a determination unit configured to determine that the third image data is identical to the first image data when a result of the comparison by the comparison unit shows that the third feature information is matched with one of the first feature information and the second feature information.

2. The information processing apparatus according to claim 1, further comprising:
an operation unit configured to accept an instruction from a user;
wherein the changing unit is configured to change the layout of the first image data in accordance with a user's instruction accepted by the operation unit.

3. The information processing apparatus according to claim 1, wherein the memory unit is configured to store, in addition to the feature information extracted by the extraction unit, information indicating a layout of the image data, from which the feature information is extracted in addition to the feature information, in a correspondent relation.

4. The information processing apparatus according to claim 1, further comprising:
an output unit configured to output information indicating a result of the determination made by the determination unit,
wherein the output unit includes at least one of a display unit that displays the information indicating the result of the determination and a printing unit that prints the information indicating the result of the determination.

5. The information processing apparatus according to claim 1, wherein the input unit includes a scanning unit that scans an image on a document to input image data.

6. The information processing apparatus according to claim 1, wherein the layout relates to an “Nin1” (N>0) layout in which a number N (N>0) of pages are arranged on one recording medium on a same side, and
wherein the changing unit changes the layout of the image data by changing a value of N in the “Nin1” layout.

7. An information processing system comprising:
an input unit configured to input image data;
an extraction unit configured to extract feature information from the image data;
a changing unit configured to change a layout of first image data input by the input unit;
a memory unit configured to store at least first feature information and second feature information in a correspondent relation, the first feature information and the second feature information being respectively extracted by the extraction unit from at least two different image data contained in plural kinds of image data having a plurality of layouts based on the first image data, the plural kinds of image data including at least the first image data and second image data of which layout is changed by the changing unit based on the first image data;
a comparison unit configured to compare third feature information extracted from third image data by the extraction unit with the first feature information and the second feature information both stored in the memory unit; and
a determination unit configured to determine that the third image data is identical to the first image data when a result of the comparison by the comparison unit shows that the third feature information is matched with one of the first feature information and the second feature information.

8. The information processing system according to claim 7, wherein the information processing system includes an information processing apparatus and a server which are connected to each other via a network,
the information processing apparatus comprising a sending unit configured to send the first feature information, the second feature information, and the third feature information to the server via the network, the input unit, the changing unit, and the extraction unit,
the server comprising a receiving unit configured to receive the first feature information, the second feature information, and the third feature information from the information processing apparatus via the network, the memory unit, the comparison unit, and the determination unit.

9. The information processing system according to claim 7, wherein the server is an originality assurance server configured to ensure that the third image data has originality when the determination unit determines that the third image data is identical to the first image data.

10. A method for an information processing system, the method comprising:
inputting image data;
extracting feature information from the image data;
changing a layout of first image data;
storing at least first feature information and second feature information in a correspondent relation, the first feature information and the second feature information being respectively extracted from at least two different image data contained in plural kinds of image data having a plurality of layouts based on the first image data, the plural kinds of image data including at least the first image data and second image data of which layout is changed based on the first image data;
comparing third feature information extracted from third image data with the first feature information and the second feature information stored; and
determining that the third image data is identical to the first image data when a result of the comparison shows that the third feature information is matched with one of the first feature information and the second feature information.

11. A program stored on a computer-readable medium for causing a computer to perform the method according to claim 10.

12. A computer-readable storage medium including a program stored thereon, the program causing a computer to perform the method according to claim 10.
